(19) United States
(12) Patent Application Publication
(10) Pub. No.: US 2009/0019450 A1
(43) Pub. Date: Jan. 15, 2009

(54) APPARATUS, METHOD, AND COMPUTER PROGRAM PRODUCT FOR TASK MANAGEMENT

(75) Inventors: Tatsuya MORI, Tokyo (JP); Hidenori Matsuzaki, Kanagawa (JP); Shigehiro Asano, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/041,325

(22) Filed: Mar. 3, 2008

(30) Foreign Application Priority Data
Jul. 11, 2007 (JP) 2007-182574

(51) Int. Cl. G06F 9/46

(52) U.S. Cl. 718/105

(57) ABSTRACT

A task management apparatus comprises a plurality of processors, and correspondingly stores, a plurality of tasks to be assigned to the processors within a predetermined period of time, and temporal groups each of which is assigned to the plurality of the tasks. The task management apparatus assigns one of the tasks to one of the processors. After having assigned the task, the task management apparatus assigns, to the one of the processors that has finished processing the assigned task, the other tasks that are in correspondence with the same temporal group as the temporal group with which the assigned task is in correspondence, before assigning the tasks that are not in correspondence with the temporal group.

### CROSS-REFERENCE TO RELATED APPLICATIONS

This application is based upon and claims the benefit of priority from the prior Japanese Patent Application No. 2007-182574, filed on Jul. 11, 2007; the entire contents of which are incorporated herein by reference.

### BACKGROUND OF THE INVENTION

1. Field of the Invention

The present invention relates to an apparatus, a method, and a computer program product for task management to perform task scheduling.

2. Description of the Related Art

Conventionally, various methods for assigning tasks to one or more processors have been proposed, as it has become popular for operating systems (OSs) to have multitasking functions. For example, universal OSs such as Linux (a registered trademark) use a scheduling method by which the right to use a processor is assigned to each of executable tasks in a descending order of the priority levels of the tasks.

When tasks are processed by one or more processors, in some situations, it is necessary to execute a plurality of tasks substantially at the same time. In these situations, if the tasks are assigned to the processors according to their priority levels, managing the tasks becomes difficult especially in a case where there are many tasks, and the scheduler may experience a delay.

To cope with this problem, JP-A 2005-18590 (KOKAI) discloses a proposal for a technique. According to this technique disclosed in JP-A 2005-18590 (KOKAI), before the execution of tasks is started, it is determined in a static manner how the tasks are to be assigned to processors and in what order the tasks are to be executed. This technique makes it possible to have the plurality of processors operate in collaboration with one another.

However, although the technique disclosed in JP-A 2005-18590 (KOKAI) is able to assign some of the tasks substantially at the same time, because the assignment is static, a problem remains where, to perform the task scheduling in advance, it is necessary to accurately estimate how long it takes to process each of the tasks.

### SUMMARY OF THE INVENTION

According to one aspect of the present invention, a task management apparatus includes a plurality of processors; a task storage unit that correspondingly stores a plurality of tasks to be assigned to the processors within a predetermined period of time and temporal groups each of which is assigned to the plurality of the tasks; a first assigning unit that assigns one of the tasks to one of the processors; and a second assigning unit that, after the first assigning unit has assigned the one of the tasks to the one of the processors, assigns other tasks that are in correspondence with a same temporal group as a temporal group with which the assigned task is in correspondence, to the one of the processors that has finished processing the assigned task, before assigning tasks that are not in correspondence with the temporal group.

According to another aspect of the present invention, a task management apparatus includes a processor; a task storage unit that correspondingly stores a plurality of tasks to be assigned to the processor within a predetermined period of time, and temporal groups each of which is assigned to a plurality of the tasks; a first assigning unit that assigns one of the tasks to the processor; and a second assigning unit that assigns to the processor, other tasks that are in correspondence with a same temporal group as a temporal group with which the assigned task is in correspondence, before assigning tasks that are not in correspondence with the temporal group.

According to still another aspect of the present invention, a task management method includes storing a plurality of tasks that are grouped to temporal groups assigned to processors within a predetermined period of time, and the temporal groups each of which is assigned to the plurality of the tasks, in correspondence with one another; first assigning one of the tasks to one of the processors; and second assigning, after the first assigning, other tasks that are in correspondence with a same temporal group as a temporal group with which the assigned task is in correspondence, to the one of the processors that has finished processing the assigned task, before assigning tasks that are not in correspondence with the temporal group.

A computer program product according to still another aspect of the present invention causes a computer to perform the method according to the present invention.

### BRIEF DESCRIPTION OF THE DRAWINGS

FIG. 1 is a block diagram of a functional configuration of a task management apparatus according to a first embodiment;

FIG. 2 is a conceptual drawing of dependency relationships among the tasks that are process targets according to the first embodiment;

FIG. 3 is a drawing for explaining a concept of storing a task process result into a cache memory and a Random Access Memory (RAM);

FIG. 4 is a drawing for explaining a concept of organizing tasks into groups based on the temporal localities thereof;

FIG. 5 is a drawing for explaining tasks have been organized into temporal locality groups;

FIG. 6 is a drawing for explaining a table structure of a task table according to the first embodiment;

FIG. 7 is a drawing for explaining a table structure of an active group management table according to the first embodiment;

FIG. 8 is a flowchart of a process procedure, from the generation of tasks to the assignment of the tasks, according to the first embodiment;

FIG. 9 is a flowchart of a procedure for assigning the tasks according to the first embodiment;

FIG. 10 is a diagram of a hardware configuration of the task management apparatus according to the first embodiment;

FIG. 11 is a block diagram of a functional configuration of a task management apparatus according to a second embodiment;

FIG. 12 is a drawing for explaining a concept of assigning priority levels to tasks having dependency relationships;

FIG. 13 is a drawing of a first example in which tasks to which priority levels have been assigned are processed by a plurality of Central Processing Units (CPUs);

FIG. 14 is a drawing of a second example in which tasks to which priority levels have been assigned are processed by a plurality of CPUs;

FIG. 15 is a drawing for explaining a concept of organizing tasks that have dependency relationships into groups, based on the temporal localities thereof;

FIG. 16 is a drawing of a first example in which tasks that have been organized into groups based on the temporal localities thereof are processed, according to the second embodiment;

FIG. 17 is a drawing of a second example in which tasks that have been organized into groups based on the temporal localities thereof are processed, according to the second embodiment;

FIG. 18 is a diagram of a hardware configuration of a task management apparatus according to the second embodiment;

FIG. 19 is a block diagram of a functional configuration of a task management apparatus according to a third embodiment;

FIG. 20 is a drawing for explaining a concept of how a task process result stored in a cache memory is used by a plurality of CPUs;

FIG. 21 is a drawing for explaining a concept of specifying CPUs that process tasks having dependency relationships;

FIG. 22 is a drawing of a first example in which the tasks for which CPUs have been specified are processed;

FIG. 23 is a drawing of a second example in which the tasks for which CPUs have been specified are processed;

FIG. 24 is a drawing for explaining a concept of organizing tasks that have dependency relationships into groups, based on the temporal localities and the spatial localities thereof;

FIG. 25 is a drawing of a first example in which the tasks that have been organized into groups based on the temporal localities and the spatial localities thereof are processed, according to the third embodiment;

FIG. 26 is a drawing of a second example in which the tasks that have been organized into groups based on the temporal localities and the spatial localities thereof are processed, according to the third embodiment;

FIG. 27 is a drawing for explaining tasks that have been organized into task groups;

FIG. 28 is a drawing for explaining a table structure of a task table according to the third embodiment;

FIG. 29 is a drawing for explaining a table structure of an active group correspondence management table according to the third embodiment;

FIG. 30 is a flowchart of a procedure for assigning tasks, according to the third embodiment;

FIG. 31 is a block diagram of a functional configuration of a task management apparatus according to a fourth embodiment;

FIG. 32 is a drawing for explaining a concept of specifying CPUs that process tasks having dependency relationships and priority levels of the tasks;

FIG. 33 is a drawing of a first example in which the tasks for which the priority levels and CPUs have been specified are processed;

FIG. 34 is a drawing of a second example in which the tasks for which the priority levels and CPUs have been specified are processed;

FIG. 35 is a conceptual drawing of a first example in which tasks having dependency relationships are organized into groups differently, based on the temporal localities thereof and based on the spatial localities thereof;

FIG. 36 is a drawing of a first example in which the tasks that have been organized into groups based on the temporal localities thereof and based on the spatial localities thereof are processed, according to the fourth embodiment;

FIG. 37 is a drawing of a second example in which the tasks that have been organized into groups based on the temporal localities thereof and based on the spatial localities thereof are processed, according to the fourth embodiment;

FIG. 38 is a drawing for explaining tasks that have been organized into task groups differently, based on the temporal localities thereof and based on the spatial localities thereof;

FIG. 39 is a drawing for explaining a table structure of a task table according to the fourth embodiment;

FIG. 40 is a drawing for explaining a table structure of an active group correspondence management table according to the fourth embodiment;

FIG. 41 is a flowchart of a procedure for assigning tasks according to the fourth embodiment;

FIG. 42 is a block diagram of a functional configuration of a task management apparatus according to a fifth embodiment;

FIG. 43 is a conceptual drawing of an example in which tasks having dependency relationships are organized into groups differently, based on the temporal localities thereof and based on the spatial localities thereof;

FIG. 44 is a drawing of an example in which the tasks that have been organized into groups differently based on the temporal localities thereof and based on the spatial localities thereof are processed, according to the fifth embodiment;

FIG. 45 is a drawing of an example in which tasks that have been organized into groups differently based on the temporal localities thereof and based on the spatial localities thereof are processed after the tasks are re-assigned, according to the fifth embodiment;

FIG. 46 is a flowchart of a procedure for assigning tasks according to the fifth embodiment;

FIG. 47 is a block diagram of a functional configuration of a task management apparatus according to a sixth embodiment;

FIG. 48 is a drawing for explaining a concept of priority ranking for the tasks to be processed by each of the CPUs, according to the sixth embodiment;

FIG. 49 is a drawing for explaining a situation in which some tasks are waiting to be processed according to the concept of the priority ranking shown in FIG. 48;

FIG. 50 is a drawing for explaining a situation in which a part of the tasks that are waiting to be processed is assigned to a third CPU, according to the concept of the priority ranking shown in FIG. 48;

FIG. 51 is a drawing for explaining a situation in which another part of the tasks that are waiting to be processed is further set so as to be active, according to the concept of the priority ranking shown in FIG. 48;

FIG. 52 is a drawing for explaining a situation in which yet another part of the tasks that are waiting to be processed is further assigned to a second CPU, according to the concept of the priority ranking shown in FIG. 48; and

FIG. 53 is a flowchart of a procedure for assigning tasks according to the sixth embodiment.

### DETAILED DESCRIPTION OF THE INVENTION

Exemplary embodiments of the present invention will be explained with reference to the accompanying drawings.

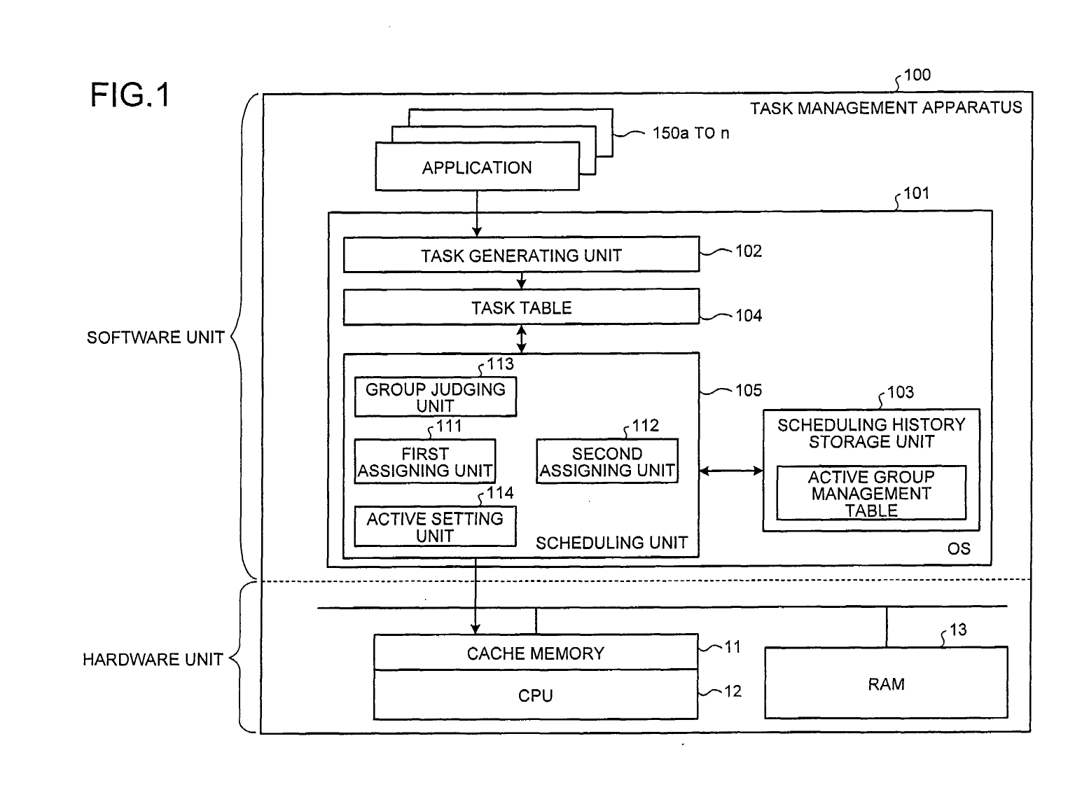

As shown in FIG. 1, a task management apparatus 100 according to a first embodiment of the present invention includes applications 150a to 150n and an operating system (OS) 101 in a software unit, as well as a cache memory 11, a Central Processing Unit (CPU) 12, and a Random Access Memory (RAM) 13 in a hardware unit.

The CPU 12 is a main processor that controls the operation of the task management apparatus 100. The CPU 12 executes tasks that have been assigned by the OS 101, which is explained later. Also, the CPU 12 has a task queue in which assigned tasks can be stored.

The cache memory 11 is a storage device provided for the CPU 12 and stores therein data that has a high possibility of being used by the CPU 12. It is possible to read and write data to and from the cache memory 11 at a higher speed than to and from the RAM 13, which is explained later. The RAM 13 is a storage device provided for the task management apparatus 100 and is used as a saving destination for data when the cache memory 11 is too full to store the data therein.

The applications 150a to 150n are applications that run on the OS 101 included in the task management apparatus 100. The applications 150a to 150n can each request the OS 101 that a process should be executed.

The OS 101 includes a task generating unit 102, a scheduling history storage unit 103, a task table 104, and a scheduling unit 105.

The task generating unit 102 generates tasks in response to the request for an execution of the process received from any of the applications 150a to 150n. Let us assume that the tasks that have been generated by the task generating unit 102 are already organized into groups.

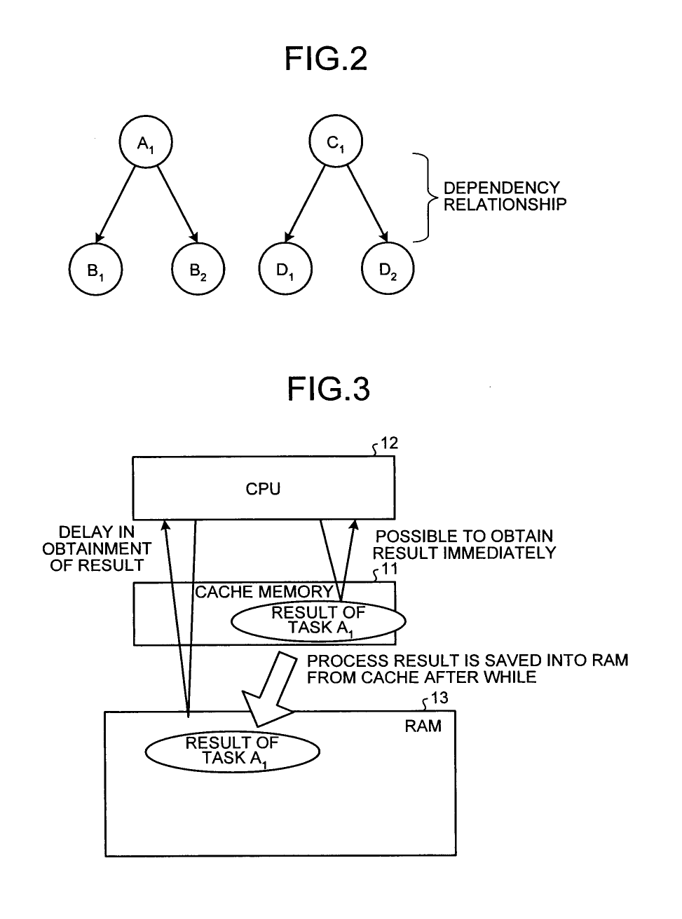

The lines that connect the tasks shown in FIG. 2 indicate dependency relationships among the tasks. In this example, tasks B₁ and B₂ are executed after a task A₁ is executed. Also, tasks D₁ and D₂ are executed after a task C₁ is executed. When the tasks have these dependency relationships, there may be a delay in the processes unless a special arrangement is made with regard to the times at which the tasks are processed.

An example in which there is a delay in the processes is a situation as shown in FIG. 3 where an execution result of the task A₁ is saved into the RAM 13 from the cache memory 11. More specifically, if the execution result of the task A₁ is stored in the cache memory 11, the CPU 12 is able to obtain the execution result of the task A₁ immediately and perform the next process using the obtained execution result. However, in a case where a task that is not related to the task A₁ is executed after the task A₁ is executed, the execution result of the task A₁ is saved into the RAM 13. In this situation, there will be a delay before the CPU 12 obtains the execution result of the task A₁ and performs the next process using the obtained execution result.

The example described above is a mere example of a situation where there is a delay during the execution of the tasks. There are various other factors that can cause a delay.

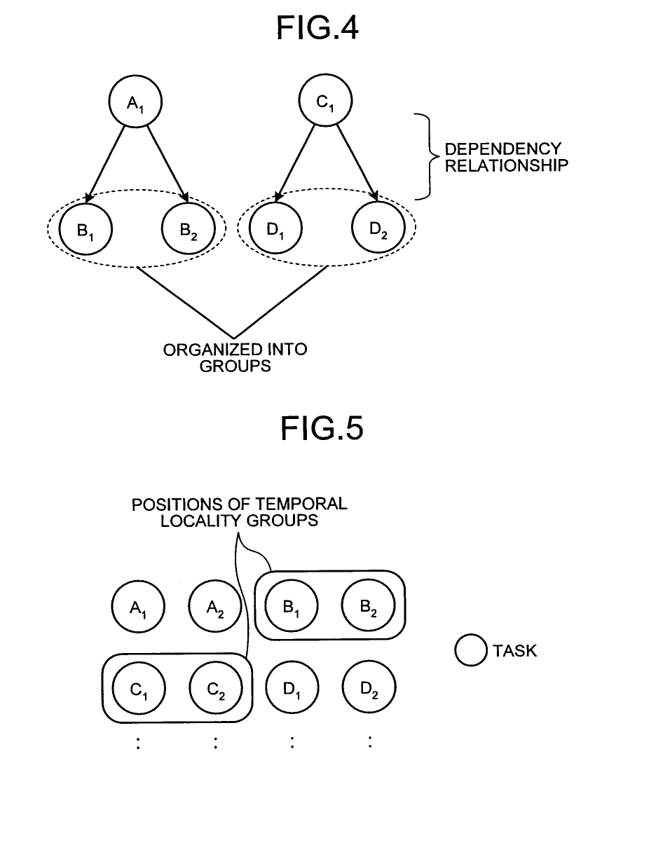

According to the first embodiment, as shown in FIG. 4, a plurality of tasks that need to be executed at points in time that are close to each other are organized into a group. In other words, as shown in FIG. 5, among the tasks that are waiting to be processed, some tasks are organized into a plurality of groups.

It is possible to solve the problem described above by further organizing tasks that use mutually the same process result into a group or organizing tasks that need to be executed with a priority into a group. In the following explanation, the concept of assigning a plurality of tasks to one or more CPUs at points in time that are close to each other will be referred to as a temporal locality. A group into which tasks have been organized based on this concept will be referred to as a temporal locality group.

When one of the tasks that belong to a temporal locality group is assigned to a CPU, control is exercised so that the other tasks in the group are also assigned to a CPU within a predetermined period of time. With this arrangement, all of the tasks that belong to the temporal group are executed at points in time that are close to each other. The predetermined period of time may be selected arbitrarily and may be changed according to the number of tasks that belong to each group, the number of CPUs being used, or the like.

It is possible to use any method for organizing the tasks into groups. For example, a developer who designs the applications 150a to 150n may explicitly describe the task groups in the program sources of the applications 150a to 150n. As another example, the processes that are performed by the applications 150a to 150n when a compiler optimizes these applications may be organized into groups.

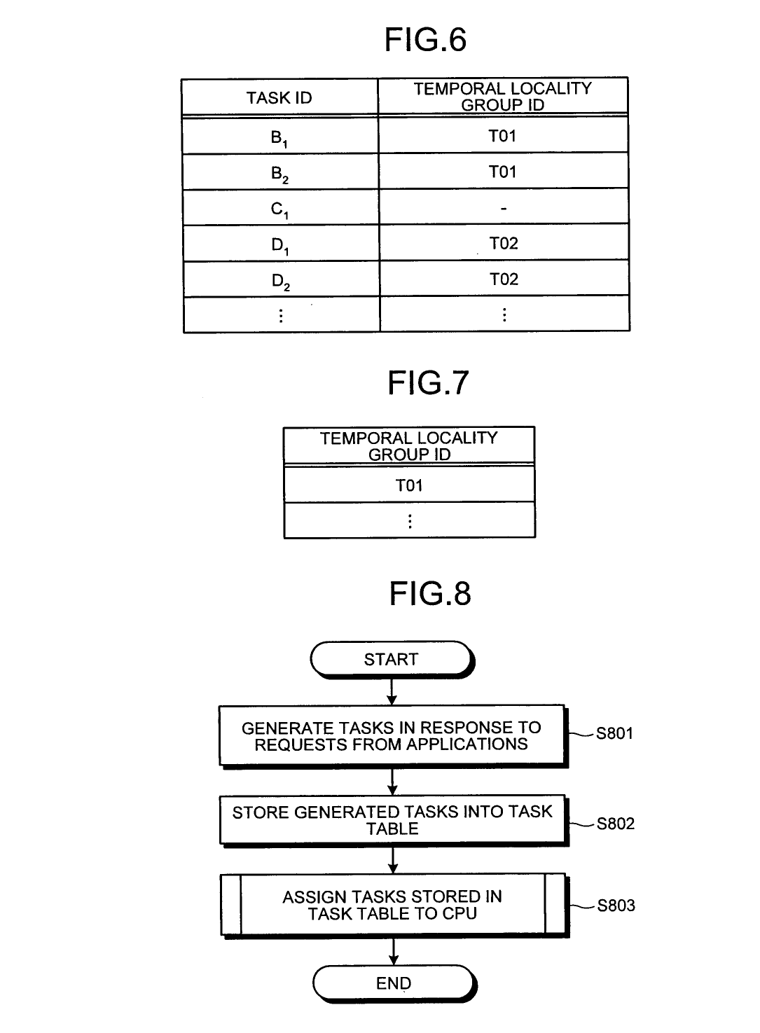

Returning to the description of FIG. 1, the task table 104 manages the tasks that have been generated by the task generating unit 102 and are waiting to be processed by the CPU 12. As shown in FIG. 6, the task table 104 stores therein task IDs and temporal locality group IDs, while keeping them in correspondence with one another. Each of the task IDs is an identifier (ID) that identifies a corresponding one of the tasks. Each of the temporal locality group IDs is an ID that identifies a corresponding one of the temporal locality groups. By using the task table 104, it is possible to identify the temporal locality group to which each of the tasks that are waiting to be processed belongs.

The scheduling history storage unit 103 stores therein an active group management table. As shown in FIG. 7, the active group management table stores therein IDs each of which identifies a temporal locality group to which a task that has already been processed by the CPU 12 or a task that is currently being processed by the CPU 12 belongs. In the following explanation, any temporal locality group to which a task that has already been processed by the CPU 12 or a task that is currently being processed by the CPU 12 belongs will be referred to as an active temporal locality group.

Returning to the description of FIG. 1, the scheduling unit 105 includes a first assigning unit 111, a second assigning unit 112, a group judging unit 113, and an active setting unit 114. The scheduling unit 105 performs a process of assigning the tasks that are managed in the task table 104 to the CPU 12.

Also, the scheduling unit 105 outputs the tasks each of which has been assigned to the CPU 12 by the first assigning unit 111 or the second assigning unit 112 to the CPU 12 via a system bus.

According to the first embodiment, the scheduling process performed by the scheduling unit 105 denotes “to determine which tasks are to be assigned to the CPU 12”. In the second embodiment and the embodiments thereafter, the scheduling process denotes “to determine which tasks are to be assigned to an arbitrary one of a plurality of CPUs”.

The group judging unit 113 judges whether there is any active temporal locality group.

In a case where there is no active temporal locality group, the first assigning unit 111 assigns the tasks that are managed in the task table 104 to the CPU 12.

In a case where there are one or more active temporal locality groups, the second assigning unit 112 assigns, to the CPU 12, the other tasks that belong to the one or more active temporal locality groups, before assigning the tasks that do not belong to the active temporal locality groups. In other words, the second assigning unit 112 assigns the other tasks that belong to the same temporal locality group as the temporal locality group to which the task that has been assigned to the CPU 12 belongs, before assigning the tasks that do not belong to the temporal locality group. In this situation, it is possible to understand whether each of the tasks belongs to the temporal locality group by referring to the correspondence relationships stored in the task table 104.

The active setting unit 114 sets the temporal locality group to which the task that has been assigned to the CPU 12 by the first assigning unit 111 belongs, so as to be an active task group.

Next, the process procedure performed by the task management apparatus, from the generation of the tasks to the assignment of the tasks to the CPU 12 will be explained, with reference to FIG. 8.

First, the task generating unit 102 generates tasks in response to requests from any of the applications 150a to 150n (step S801).

Secondly, the task generating unit 102 stores the generated tasks into the task table 104 (step S802).

After that, the scheduling unit 105 assigns the tasks that are stored in the task table 104 to the CPU 12 (step S803). The details of the assigning procedure will be explained later.

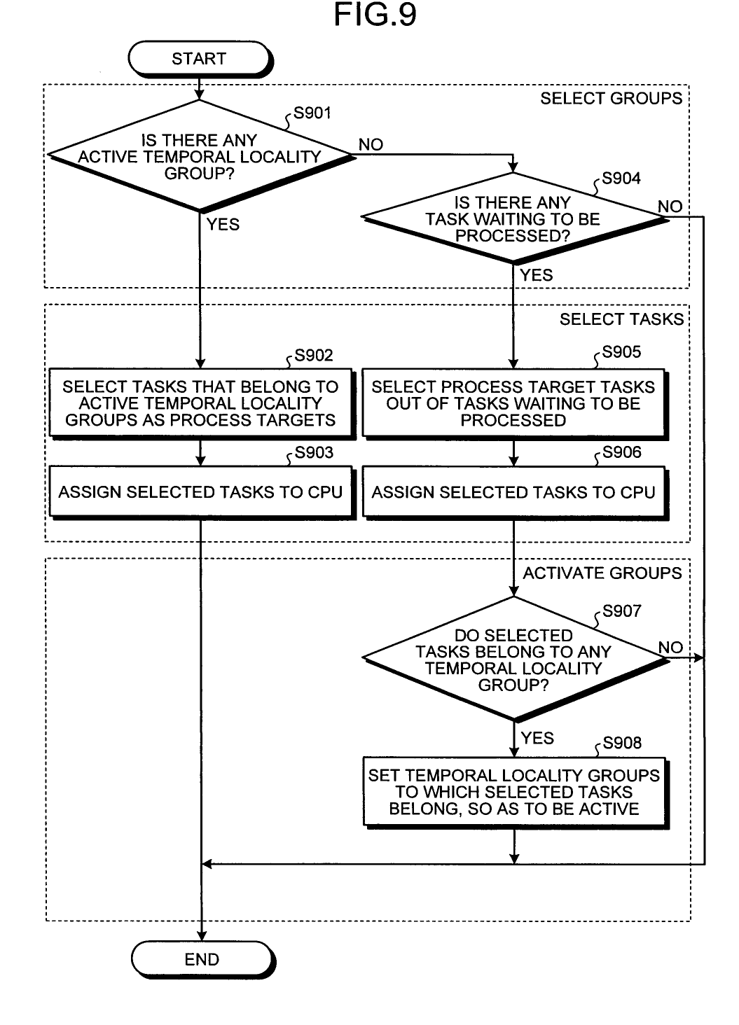

Next, the procedure performed by the task management apparatus 100 to assign the tasks to the CPU 12 will be explained, with reference to FIG. 9.

First, the group judging unit 113 judges whether there is any active temporal locality group, by referring to the active group management table (step S901).

In a case where the group judging unit 113 has judged that there are one or more active temporal locality groups (step S901: Yes), the second assigning unit 112 selects the tasks that belong to the one or more active temporal locality groups as process targets, out of the task table 104 (step S902).

After that, the second assigning unit 112 assigns the selected tasks to the CPU 12 (step S903).

On the contrary, in a case where the group judging unit 113 has judged that there is no active temporal locality group (step S901: No), the group judging unit 113 judges whether there is any task that is waiting to be processed, by referring to the task table 104 (step S904). In a case where the group judging unit 113 has judged that there is no task that is waiting to be processed (step S904: No), the process is ended.

On the contrary, in a case where the group judging unit 113 has judged that there are one or more tasks that are waiting to be processed (step S904: Yes), the first assigning unit 111 selects tasks that serve as process targets, out of the tasks that are stored in the task table 104 and are waiting to be processed (step S905).

After that, the first assigning unit 111 assigns the selected tasks to the CPU 12 (step S906).

Subsequently, the active setting unit 114 judges whether the tasks that have been selected by the first assigning unit 111 belong to any temporal locality group (step S907). In a case where the active setting unit 114 has judged that the selected tasks do not belong to any temporal locality group (step S907: No), the process is ended.

On the contrary, in a case where the active setting unit 114 has judged that the selected tasks belong to one or more temporal locality groups (step S907: Yes), the active setting unit 114 sets each of the temporal locality groups to which the selected tasks belong, so as to be active (step S908). According to the first embodiment, the active setting unit 114 registers the IDs that identify the temporal locality groups into the active group management table.

As a result of the process procedure described above, it is possible to process the tasks that belong to each of the temporal locality groups at points in time that are close to each other.

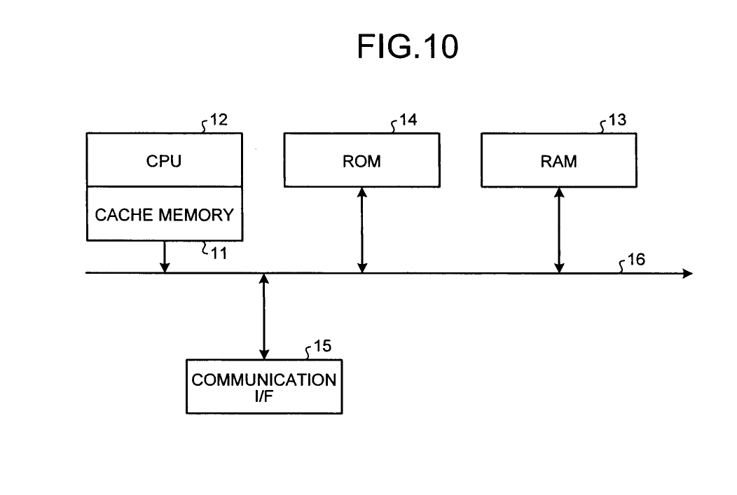

As shown in FIG. 10, the task management apparatus 100 according to the first embodiment includes the CPU 12, the cache memory 11, the ROM 14, the RAM 13, a communication interface (I/F) 15, and a bus 16 that connects these elements to one another. The task management apparatus 100 has a hardware configuration for which a commonly-used computer can be used.

A task management program that is executed by the task management apparatus 100 according to the first embodiment is provided as being incorporated, in advance, in the ROM 14 or the like.

The task table 104 according to the first embodiment as described above stores therein the task IDs and the temporal locality group IDs, while keeping them in correspondence with one another. In other words, in the task management apparatus 100, the scheduling unit 105 performs the process described above by using the information managed in the task table 104. As a result, it is possible to process the tasks that belong to each of the temporal locality groups at the points in time that are close to each other. Thus, the task management apparatus 100 is able to efficiently assign the tasks to the CPU 12. Consequently, the task management apparatus 100 is able to improve the processing efficiency of the CPU.

Also, in the task management apparatus 100 according to the first embodiment, because the tasks that belong to mutually the same temporal locality group are executed in succession, it is possible to prevent the other tasks from using a shared cache. This situation allows the data to be forwarded and received among the tasks via the shared cache. Consequently, it is possible to perform the processes quickly.

In the description of the first embodiment, the example in which the task management apparatus 100 includes only one CPU is explained. Next, in a second embodiment of the present invention, an example in which a task management apparatus includes a plurality of CPUs will be explained.

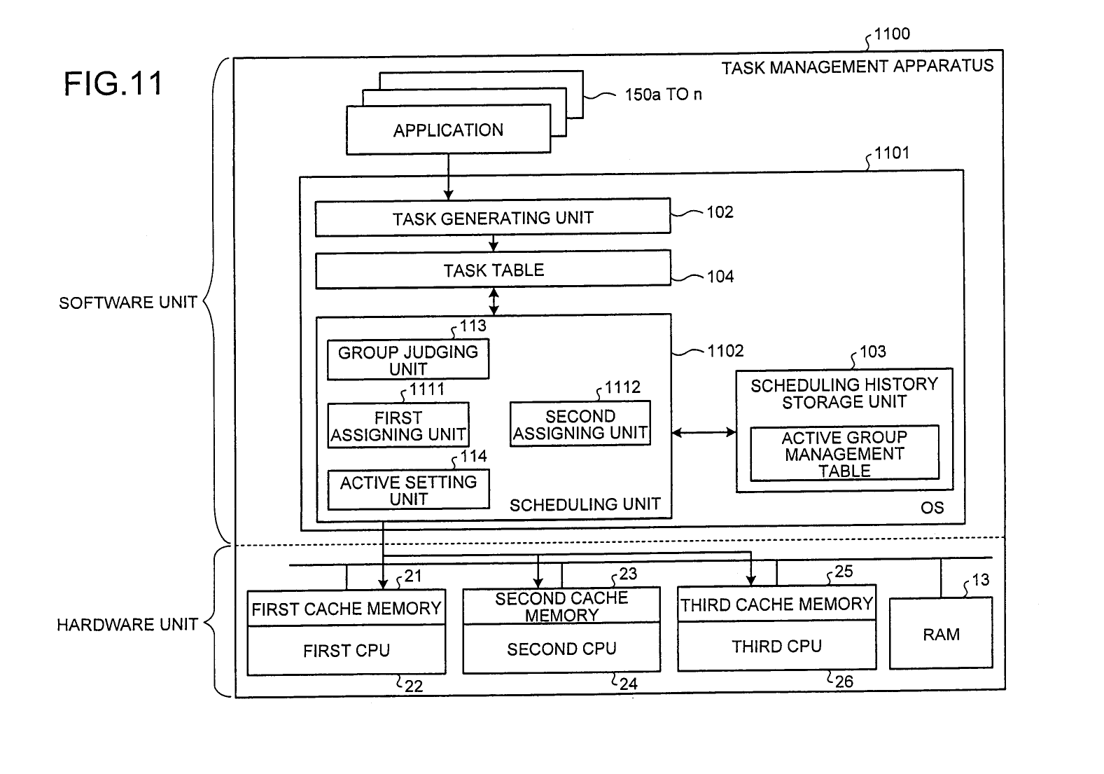

As shown in FIG. 11, a task management apparatus 1100 according to the second embodiment is different from the task management apparatus 100 according to the first embodiment in that the task management apparatus 1100 includes an OS 1101 that performs different processes from the ones performed by the OS 101, and that the task management apparatus 1100 includes three CPUs and three cache memories. The three CPUs and the three cache memories will be referred to as a first CPU 22, a second CPU 24, a third CPU 26, a first cache memory 21, a second cache memory 23, and a third cache memory 25. Also, the OS 1101 is different from the OS 101 according to the first embodiment in that the OS 1101 includes a scheduling unit 1102, instead of the scheduling unit 105. Explanation of the configurations of the task management apparatus 1100 according to the second embodiment that are the same as the configurations of the task management apparatus 100 according to the first embodiment will be omitted.

In the task management apparatus 1100 according to the second embodiment, a multi core processor system is used so that the three processors (i.e., the first CPU 22, the second CPU 24, and the third CPU 26) are mutually connected to the OS 1101 via a system bus.

The configurations of the first CPU 22, the second CPU 24, and the third CPU 26 are each the same as the configuration of the CPU 12 according to the first embodiment. Thus, the explanation thereof will be omitted. Also, the configurations of the first cache memory 21, the second cache memory 23, and the third cache memory 25 are each the same as the configuration of the cache memory 11 according to the first embodiment. Thus, the explanation thereof will be omitted.

The scheduling unit 1102 includes the group judging unit 113, a first assigning unit 1111, a second assigning unit 1112, and the active setting unit 114.

In a case where there is no active temporal locality group, the first assigning unit 1111 assigns one of the tasks that are managed in the task table 104 to one of the first CPU 22, the second CPU 24, and the third CPU 26.

In a case where there are one or more active temporal locality groups, the second assigning unit 1112 assigns, to the first CPU 22, the second CPU 24, or the third CPU 26, the other tasks that belong to the same temporal locality group as the temporal locality group to which the task that has been assigned by the first assigning unit 1111 belongs, before assigning the tasks that do not belong to the temporal locality group.

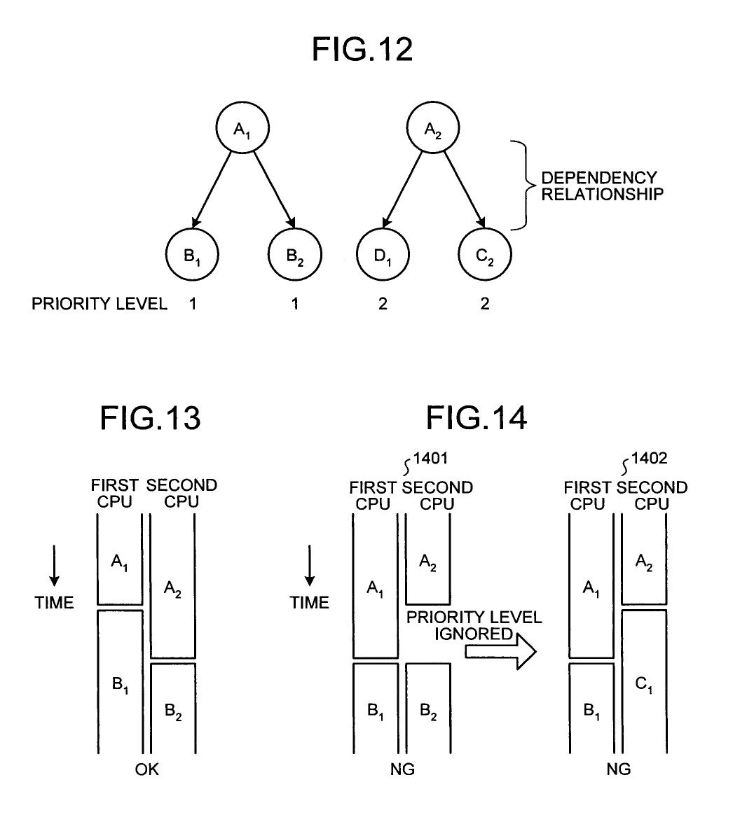

First, a conventional method for assigning tasks will be explained. As shown in FIG. 12, in a conventional task scheduling process, a priority level is given to each of the tasks. For example, Priority Level 1 is given to the task B, and to the task B₂, while Priority Level 2 is given to the task C₁ and to the task C₂.

With this arrangement, as shown in FIG. 13, in a case where the task Al assigned to the first CPU 22 has finished being executed before the task A₂ assigned to the second CPU 24, it is possible to execute the tasks B₁ and B₂ at points in time that are close to each other, based on their priority levels.

However, in a case where the task A₂ assigned to the second CPU 24 has finished being executed before the task A₁ assigned to the first CPU 22, the second CPU 24 does not perform the process until the first CPU 22 finishes executing the task A₁, as shown with a reference character 1401 in FIG. 14. Thus, the processing efficiency is lowered.

Alternatively, in a case where the tasks are assigned to the CPUs while the priority levels are ignored as shown with a reference character 1402, the processing efficiency will not be lowered, but it is difficult to achieve the goal of executing a plurality of tasks (e.g., the tasks B₁ and B₂) at points in time that are close to each other.

In other words, according to the conventional technique, depending on the order in which the tasks finish being executed by the CPUs, other tasks that follow these tasks may have to wait, and the level of performance may be lowered. On the contrary, in the case where the scheduling process is performed while the priority levels are ignored so that the level of performance is prevented from being lowered, the temporal localities during the execution of the tasks are lost.

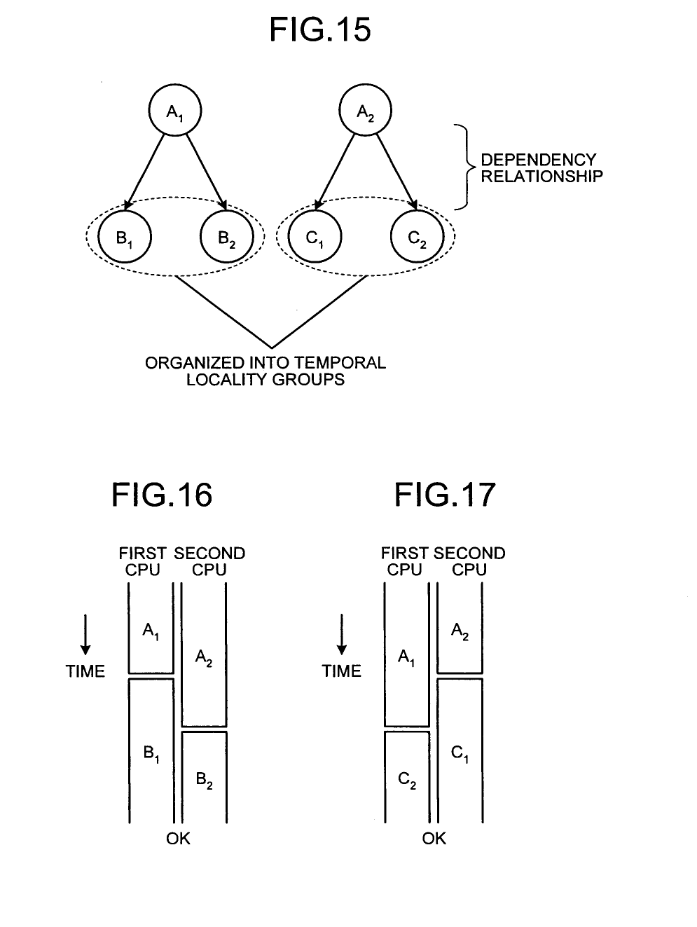

In contrast, the task management apparatus 1100 according to the second embodiment organizes, into a group, tasks that need to be processed at points in time that are close to each other, instead of setting a priority level for each of the tasks. The organized group will be referred to as a temporal locality group, like in the first embodiment. As shown in FIG. 15, the tasks B₁ and B₂ are organized into one task group, while the tasks C₁ and C₂ are organized into another task group. The process that is performed when the tasks are organized into the groups is the same as the one performed according to the first embodiment.

With this arrangement, as shown in FIG. 16, when the task A₁ assigned to the first CPU 22 has finished being processed, the task B₁ is assigned to the first CPU 22. After that, when the task A₂ assigned to the second CPU 24 has finished being processed, the task B₂, which belongs to the same temporal locality group as the one to which the task B₁ belongs, is assigned to the second CPU 24. As a result, it is possible to execute the tasks B₁ and B₂ at points in time that are close to each other.

On the contrary, as shown in FIG. 17, when the task A₂ assigned to the second CPU 24 has finished being processed, the task C₁ is assigned to the second CPU 24. After that, when the task A₁ assigned to the first CPU 22 has finished being processed, the task C₂, which belongs to the same temporal locality group as the one to which the task C₁ belongs, is assigned to the first CPU 22. As a result, it is possible to execute the tasks C₁ and C₂ at points in time that are close to each other. Consequently, the task management apparatus 1100 according to the second embodiment is able to maintain both the level of performance and the temporal localities, without being dependent on the order in which the tasks finish being executed by the CPUs.

The task management apparatus 1100 according to the second embodiment is able to execute the tasks at points in time that are close to each other, regardless of when the CPUs included in the multi core processor system finish processing the tasks, as long as the tasks belong to a temporal locality group. Also, in this situation, there will be no waiting period in the task management apparatus 1100 because the tasks are assigned among the CPUs. As a result, the task management apparatus 1100 is able to efficiently assign the tasks to the CPUs (i.e., the first CPU 22, the second CPU 24, and the third CPU 26). Consequently, the task management apparatus 1100 according to the second embodiment is able to achieve the same advantageous effects as the ones achieved by the task management apparatus 100 according to the first embodiment.

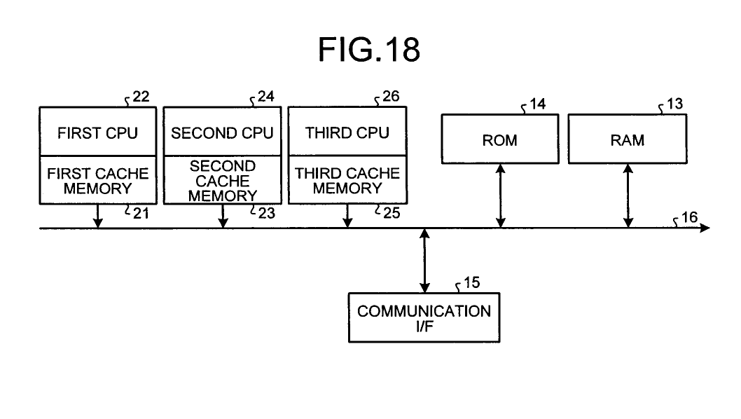

In addition, as shown in FIG. 18, the task management apparatus 1100 according to the second embodiment includes the first cache memory 21, the first CPU 22, the second cache memory 23, the second CPU 24, the third cache memory 25, the third CPU 25, the ROM 14, the RAM 13, the communication I/F 15, and the bus 16 that connects these elements to one another. The task management apparatus 1100 has a hardware configuration for which a commonly-used computer can be used.

A task management program that is executed by the task management apparatus 1100 according to the second embodiment is provided as being incorporated, in advance, in the ROM 14 or the like. The task management apparatus according to any of the exemplary embodiments described below has the same hardware configuration. Thus, the explanation thereof will be omitted.

According to the first and the second embodiments described above, the tasks are organized into groups by using temporal locality groups. However, the grouping of the tasks is not limited by the concept of temporal localities. Thus, according to a third embodiment of the present invention, an example in which tasks are organized into groups by using a concept other than temporal localities will be explained.

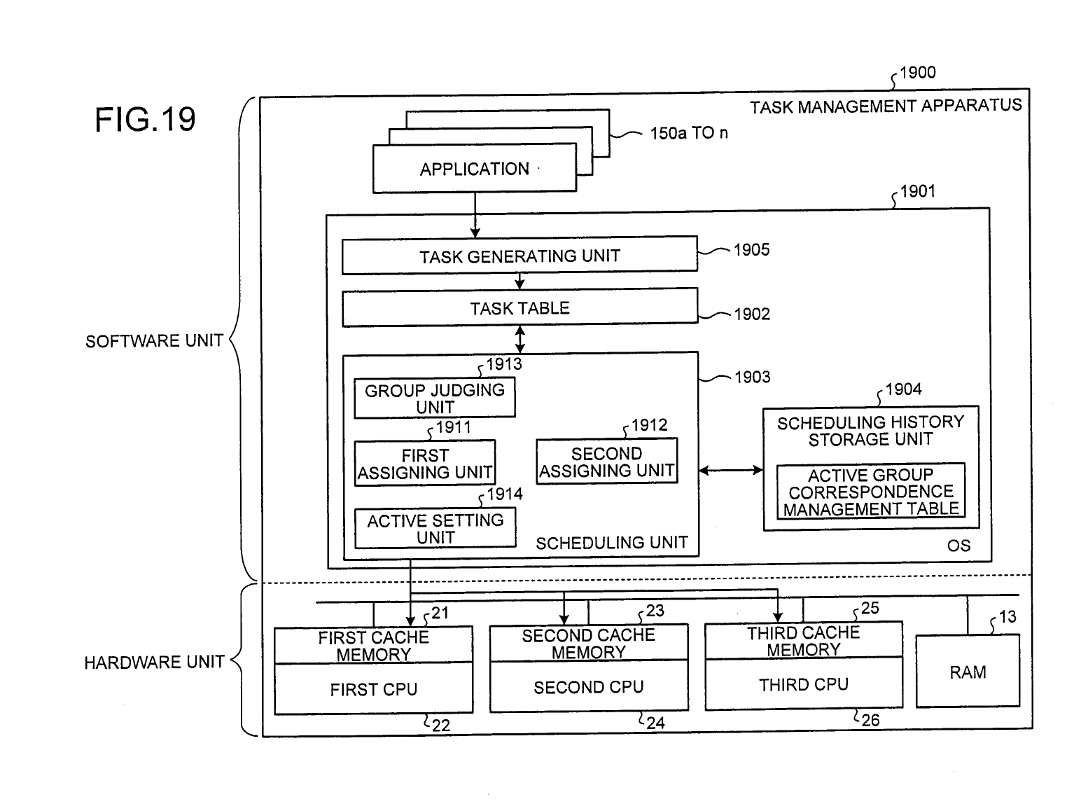

As shown in FIG. 19, a task management apparatus 1900 according to the third embodiment is different from the task management apparatus 1100 according to the second embodiment only in that the task management apparatus 1900 includes an OS 1901 that performs different processes from the ones performed by the OS 1101. Also, the OS 1901 is different from the OS 1101 according to the second embodiment in that the OS 1901 includes: a task generating unit 1905 instead of the task generating unit 102; a task table 1902 instead of the task table 104; a scheduling unit 1903 instead of the scheduling unit 1102; and a scheduling history storage unit 1904 instead of the scheduling history storage unit 103. Explanation of the configurations of the task management apparatus 1900 according to the third embodiment that are the same as the configurations of the task management apparatus 1100 according to the second embodiment will be omitted.

The task generating unit 1905 generates tasks that are organized into groups based on the temporal localities and the spatial localities thereof, in response to a request for an execution of processes received from any of the applications 150a to 150n. The term “spatial localities” denotes a concept of assigning a plurality of tasks to mutually the same CPU. In other words, of the tasks that have been generated by the task generating unit 1905, a plurality of tasks that belong to mutually the same group will be processed by mutually the same CPU at points in time that are close to each other.

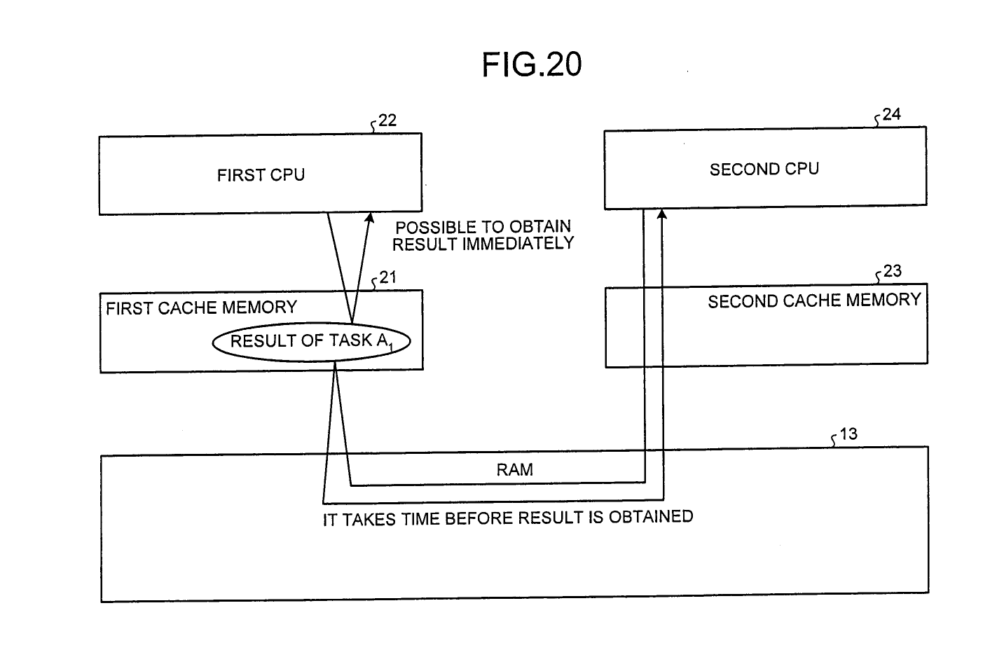

Next, an advantageous feature that is obtained when tasks are organized into groups based on the spatial localities thereof will be explained by using an example. As shown in FIG. 20, in a case where the task A₁ is processed by the first CPU 22, and an execution result of the task A₁ is stored into the first cache memory 21, a task that uses the execution result of the task A₁ is able to obtain the execution result immediately if executed by the first CPU 22. On the contrary, if the task that uses the execution result of the task A₁ is executed by the second CPU 24, there will be a delay because the task needs to obtain the execution result via the RAM 13 and the system bus. To cope with this problem, the task management apparatus 1900 according to the third embodiment executes the tasks after organizing the tasks into groups based on, not only the temporal localities thereof, but also the spatial localities thereof.

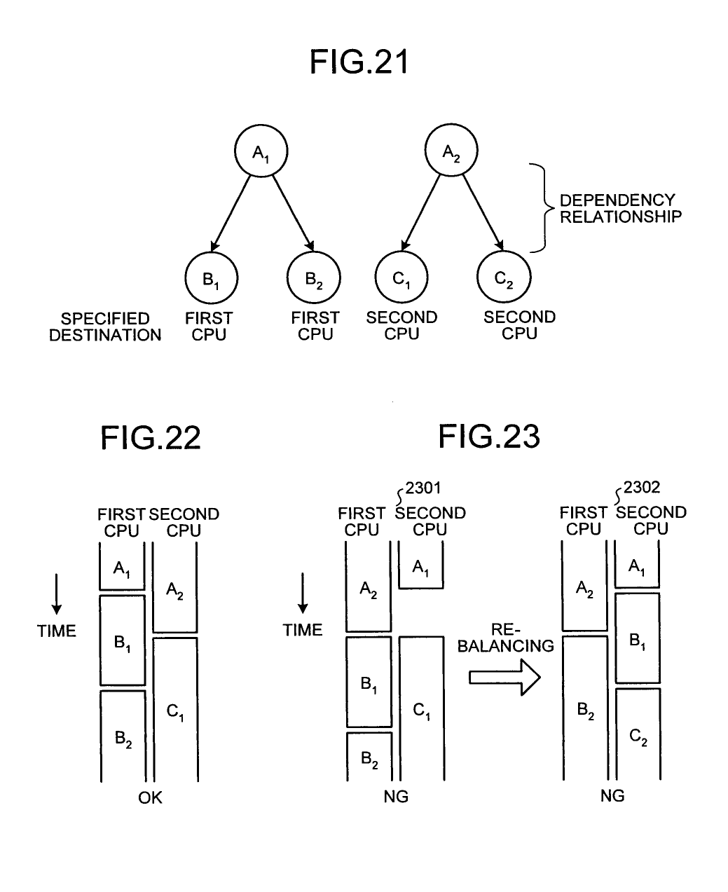

According to a conventional technique, in a case where a plurality of tasks need to be processed in succession by one CPU, it is possible to specify a CPU that processes each of the tasks, as shown in FIG. 21. In this situation, as shown in FIG. 22, it is possible to efficiently process the tasks in a case where the task A₁ is executed by the first CPU 22, whereas the task A₂ is executed by the second CPU 24.

However, in a case where the task A₂ is executed by the first CPU 22, whereas the task A₁ is executed by the second CPU 24 as shown with a reference character 2301 in FIG. 23, even after the task A₁ assigned to the second CPU 24 has finished being executed, it is not possible to assign tasks B₁ and B₂ to any CPU until the task A₂ assigned to the first CPU 22 finishes being executed. In other words, the second CPU 24 does not perform the process until the task A₂ assigned to the first CPU 22 finishes being processed.

Further, as shown with a reference character 2302, in a case where the task B₁ is assigned to the second CPU 24 by performing a re-balancing process, it is possible to prevent the second CPU 24 from waiting for the next process, but it is not possible to maintain the spatial localities.

In other words, according to the conventional technique, depending on when each of the CPUs finishes the executing of the tasks, following tasks may have to wait, and the level of performance may be lowered. On the other hand, in the case where the re-scheduling process (i.e., the re-balancing process) is dynamically performed when any of the CPUs goes into a waiting state so that the level of performance is prevented from being lowered, the spatial localities among the tasks are lost.

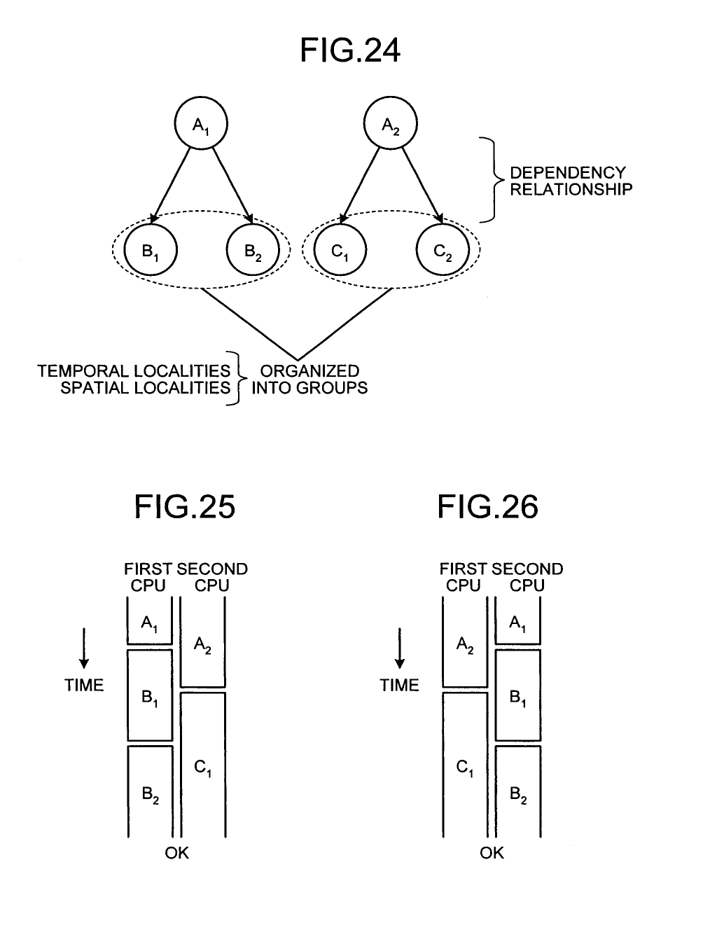

To cope with this problem, the task management apparatus 1900 according to the third embodiment assigns the tasks to the CPUs, after organizing the tasks into groups based on the spatial localities thereof. As shown in FIG. 24, the task management apparatus 1900 according to the third embodiment organizes, in advance, tasks that need to be processed by mutually the same CPU into one group. The method for organizing the tasks into the groups is the same as the one used in the exemplary embodiments described above.

Because the task management apparatus 1900 according to the third embodiment organizes the tasks into the groups as described above, as shown in FIG. 25, after the task A₁ has finished being processed by the first CPU 22, the tasks B₁ and B₂ that are organized into one group based on the spatial localities thereof are assigned to the first CPU 22. Also, after the task A₂ has finished being processed by the second CPU 24, the tasks C₁ and C₂ that are organized into one group based on the spatial localities thereof are assigned to the second CPU 24.

Further, as shown in FIG. 26, in a case where the task A₂ is processed by the first CPU 22, whereas the task A₁ is processed by the second CPU 24, after the task A₁ has finished being processed by the second CPU 24, the tasks B₁ and B₂ are assigned to the second CPU 24. After the task A₂ has finished being processed by the first CPU 22, the tasks C₁ and C₂ are assigned to the first CPU 22.

As explained above, because the tasks are organized into groups by using the spatial locality groups, it is possible to efficiently process the tasks. In other words, the task management apparatus 1900 according to the third embodiment is able to maintain both the level of performance and the spatial localities, without being dependent on which CPU processes each of the tasks.

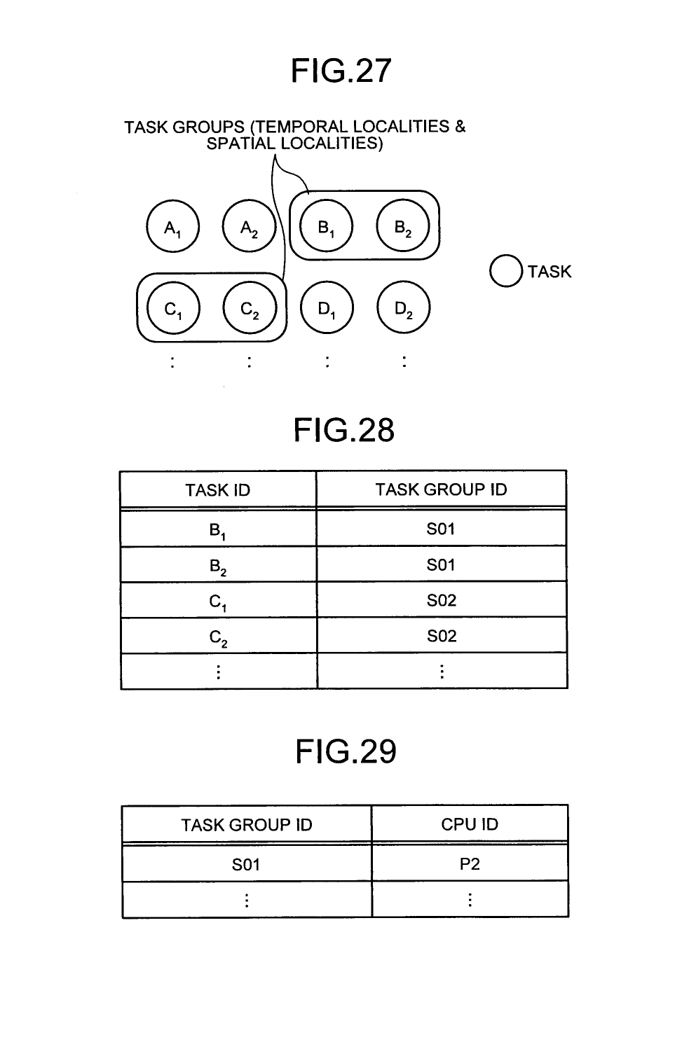

Also, as shown in FIG. 27, in the task management apparatus 1900 according to the third embodiment, each of the tasks does not belong to more than one task group. In other words, each of the tasks belongs to one task group (i.e., either a spatial locality task group or a temporal locality task group) or does not belong to any task group.

Returning to the description of FIG. 19, the task table 1902 manages the tasks that have been generated by the task generating unit 1905 and are waiting to be processed by the CPUs. As shown in FIG. 28, the task table 1902 stores therein the task IDs and task group IDs while keeping them in correspondence with one another.

Returning to the description of FIG. 19, the scheduling history storage unit 1904 stores therein an active group correspondence management table. As shown in FIG. 29, the active group correspondence management table stores therein task group IDs and CPU IDs, while keeping them in correspondence with one another. In other words, in the active group correspondence management table, each of the task groups that are respectively identified with the task group IDs is assigned to one of the CPUs that are respectively identified with the CPU IDs.

Returning to the description of FIG. 19, the scheduling unit 1903 includes a group judging unit 1913, a first assigning unit 1911, a second assigning unit 1912, and an active setting unit 1914.

The group judging unit 1913 judges, when a task is assigned to an arbitrary one of the CPUs, whether there is any task group that has been assigned to the arbitrary one of the CPUs.

In a case where there is no task group that has been assigned to the CPU (the first CPU 22, the second CPU 24, or the third CPU 26), the first assigning unit 1911 assigns, to the CPU, tasks that are waiting to be processed and do not belong to any of the task groups that have been assigned to the other CPUs, out of the tasks that are managed in the task table 1902.

In a case where there are one or more task groups that have been assigned to the CPU, the second assigning unit 1912 assigns, to the CPU (i.e., the first CPU 22, the second CPU 24, or the third CPU 26) that has finished processing the task assigned by the first assigning unit 1911, the other tasks that belong to the same task group as the one to which the task that has been assigned to the CPU belongs, before assigning the tasks that do not belong to the task group.

The active setting unit 1914 sets the task group that has been assigned to the CPU (i.e., the first CPU 22, the second CPU 24, or the third CPU 26) by the first assigning unit 1911, so as to be an active task group for the CPU.

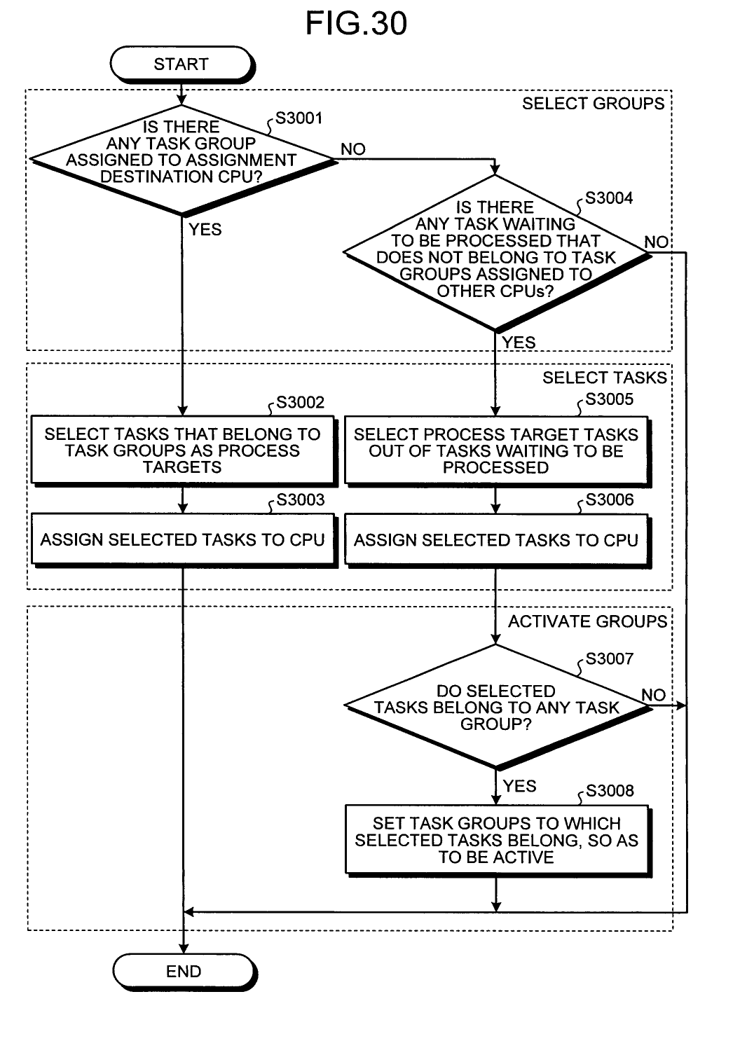

The task management apparatus 1900 according to the third embodiment is different from the task management apparatus 100 only in the procedure for assigning the tasks to the CPUs. Thus, the procedure performed by the task management apparatus 1900 to assign the tasks to the CPUs will be explained, with reference to FIG. 30. In the explanation of the processes below, a CPU to which one or more tasks are assigned will be referred to as an “assignment destination CPU”.

First, the group judging unit 1913 judges whether there is any task group that has been assigned to an assignment destination CPU (step S3001). The group judging unit 1913 is able to check to see whether there is any task group that has been assigned, by referring to the active group correspondence management table shown in FIG. 29.

In a case where the group judging unit 1913 has judged that there are one or more task groups that have been assigned (step S3001: Yes), the second assigning unit 1912 selects tasks that belong to the one or more task groups as process targets, out of the task table 1902 (step S3002).

Next, the second assigning unit 1912 assigns the selected tasks to the assignment destination CPU (step S3003).

On the contrary, in a case where the group judging unit 1913 has judged that there is no task group that has been assigned (step S3001: No), the group judging unit 1913 judges whether there is any task that is waiting to be processed, by referring to the task table 1902 (step S3004). In a case where the group judging unit 1913 has judged that there is no task that is waiting to be processed (step S3004: No), the process is ended.

On the contrary, in a case where the group judging unit 1913 has judged that there are one or more tasks that are waiting to be processed (step S3004: Yes), the first assigning unit 1911 selects tasks that serve as process targets, out of the tasks that are stored in the task table 1902 and are waiting to be processed (step S3005).

The first assigning unit 1911 then assigns the selected tasks to the assignment destination CPU (step S3006).

After that, the active setting unit 1914 judges whether the tasks that have been selected by the first assigning unit 1911 belong to any task group (step S3007). In a case where the active setting unit 1914 has judged that the selected tasks do not belong to any task group (step S3007: No), the process is ended.

On the contrary, in a case where the active setting unit 1914 has judged that the selected tasks belong to one or more task groups (step S3007: Yes), the active setting unit 1914 sets the one or more task groups to which the selected tasks belong, so as to be process targets of the assignment destination CPU (step S3008). According to the third embodiment, the active setting unit 1914 registers the IDs that identify the task groups into the active group correspondence management table.

With these arrangements, the task management apparatus 1900 according to the third embodiment is able to achieve the same advantageous effects as the ones achieved by the task management apparatus 1100 according to the second embodiment. In addition, the tasks that belong to mutually the same task group are executed in succession by mutually the same CPU. This situation allows the data to be forwarded and received among the tasks via the cache memories included in the CPUs. Thus, it is possible to improve the processing efficiency.

According to a fourth embodiment of the present invention, an example will be explained in which tasks are organized into groups based on the temporal localities thereof and also based on the spatial localities thereof.

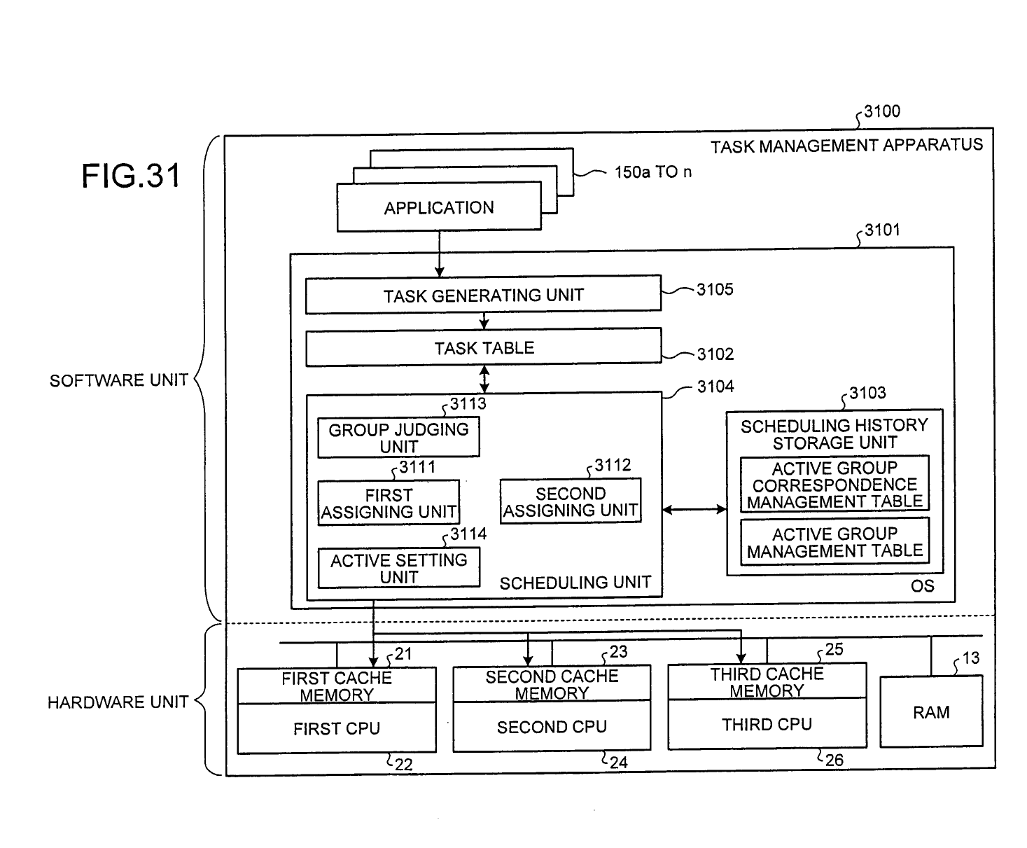

As shown in FIG. 31, a task management apparatus 3100 according to the fourth embodiment is different from the task management apparatus 1900 according to the third embodiment only in that the task management apparatus 3100 includes an OS 3101 that performs different processes from the ones performed by the OS 1901.

Also, the OS 3101 is different from the OS 1901 according to the third embodiment in that the OS 3101 includes a task generating unit 3105 instead of the task generating unit 1905; a task table 3102 instead of the task table 1902; a scheduling unit 3104, instead of the scheduling unit 1903; and a scheduling history storage unit 3103 instead of the scheduling history storage unit 1904.

Explanation of the configurations of the task management apparatus 3100 according to the fourth embodiment that are the same as the configurations of the task management apparatus 1900 according to the third embodiment will be omitted.

The task generating unit 3105 generates tasks each of which belongs to a temporal locality group and/or a spatial locality group, in response to a request for an execution of processes from any of the applications 150a to 150n. The tasks that belong to each temporal locality group are tasks that are to be processed at points in time that are close to each other. The tasks that belong to each spatial locality group are tasks that are to be processed by mutually the same CPU.

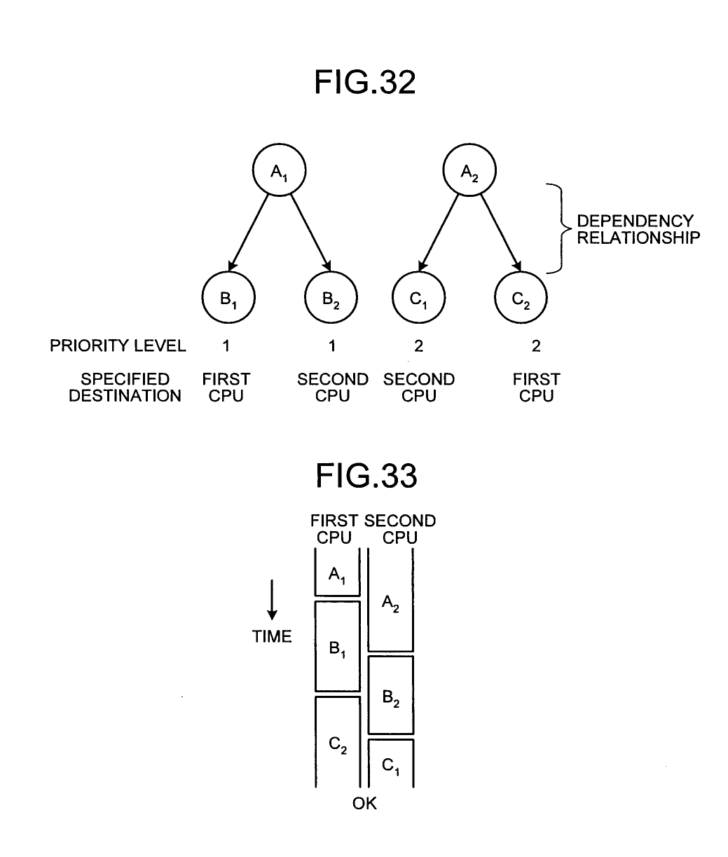

According to a conventional technique, in a case where a plurality of tasks need to be processed by one CPU at points in time that are close to each other, an arrangement can be made by specifying a CPU that processes each of the tasks as well as the priority level of each of the tasks, as shown in FIG. 32. In this situation, as shown in FIG. 33, it is possible to efficiently process the tasks if the task A₁ is executed by the first CPU 22, whereas the task A₂ is executed by the second CPU 24.

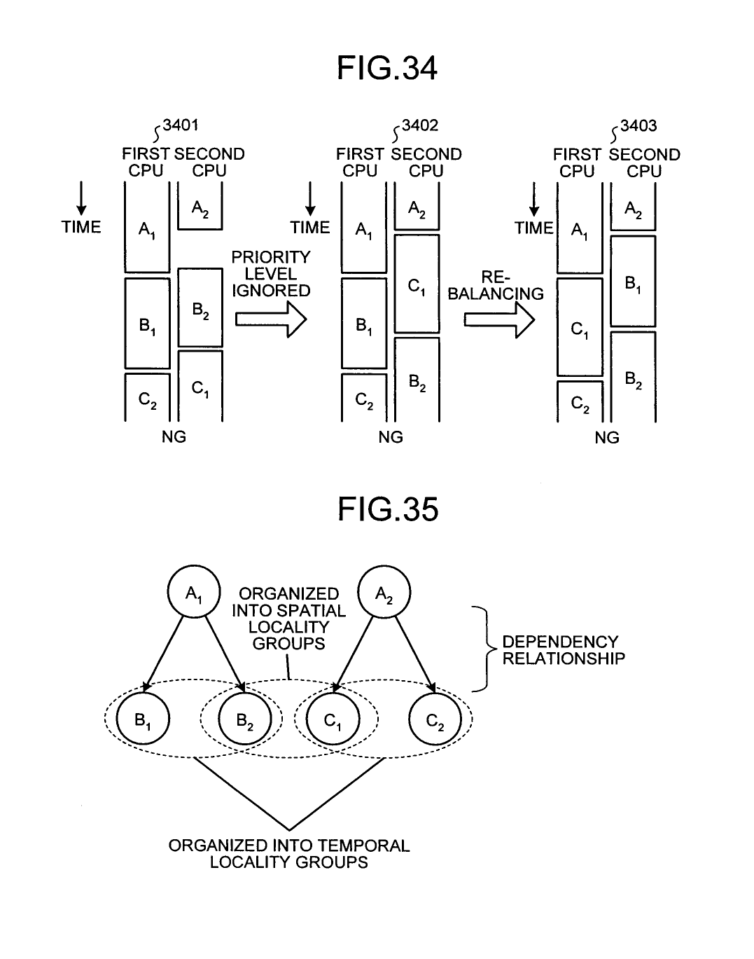

However, as shown with a reference character 3401 in FIG. 34, in a case where the task A₂ has finished being processed by the second CPU 24 before the task A₁ finishes being processed by the first CPU 22, the second CPU 24 is not able to process task B₂, until the first CPU 22 finishes processing the task A₁.

Further, as shown with a reference character 3402, in a case where the priority levels are ignored, although the second CPU 24 is able to perform the process immediately, it is not possible to process the tasks B₁ and B₂ at points in time that are close to each other.

In addition, as shown with a reference character 3403, in a case where a re-balancing process is performed, although the second CPU 24 is able to perform the process immediately, it is not possible to maintain the spatial localities.

In other words, according to the conventional technique, depending on the order in which the tasks finish being processed, or depending on which CPU processes each of the tasks, following tasks may have to wait, and the level of performance may be lowered. Further, in a case where the scheduling process is performed while the priority levels are ignored so that the level of performance is prevented from being lowered, the temporal localities during the execution of the tasks are lost. In addition, in a case where a re-scheduling process (i.e., a re-balancing process) is dynamically performed after some tasks go into waiting state, the spatial localities with regard to the execution of the tasks are lost.

To cope with this problem, the task management apparatus 3100 according to the fourth embodiment assigns the tasks to the CPUs after organizing the tasks into groups by using spatial locality groups and temporal locality groups. As shown in FIG. 35, in the task management apparatus 3100 according to the fourth embodiment, the temporal locality groups and the spatial locality groups are different from one another.

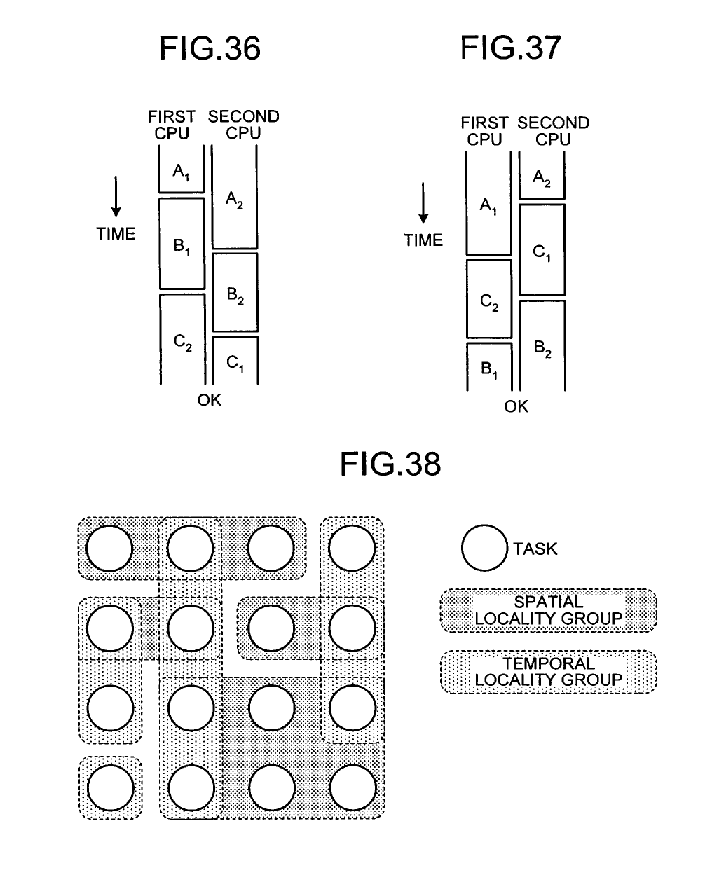

As a result, because the task management apparatus 3100 according to the fourth embodiment organizes the tasks into the groups by using temporal locality groups and spatial locality groups, it is possible to, as required, maintain the temporal localities and the spatial localities in a case where the task A₂ has finished being processed by the second CPU 24 after the task A₁ finishes being processed by the first CPU 22, as shown in FIG. 36.

Also, in the task management apparatus 3100, as shown in FIG. 37, it is possible to maintain the levels of performance of the CPUs as well as the temporal localities and the spatial localities, even if the task A₁ has finished being processed by the first CPU 22 after the task A₂ finishes being processed by the second CPU 24.

Also, in the task management apparatus 3100 according to the fourth embodiment, as shown in FIG. 38, each of the tasks belongs to a spatial locality group and/or a temporal locality group. Although not shown in the drawing, another arrangement is acceptable in which some of the tasks belong to neither a spatial locality group nor a temporal locality group.

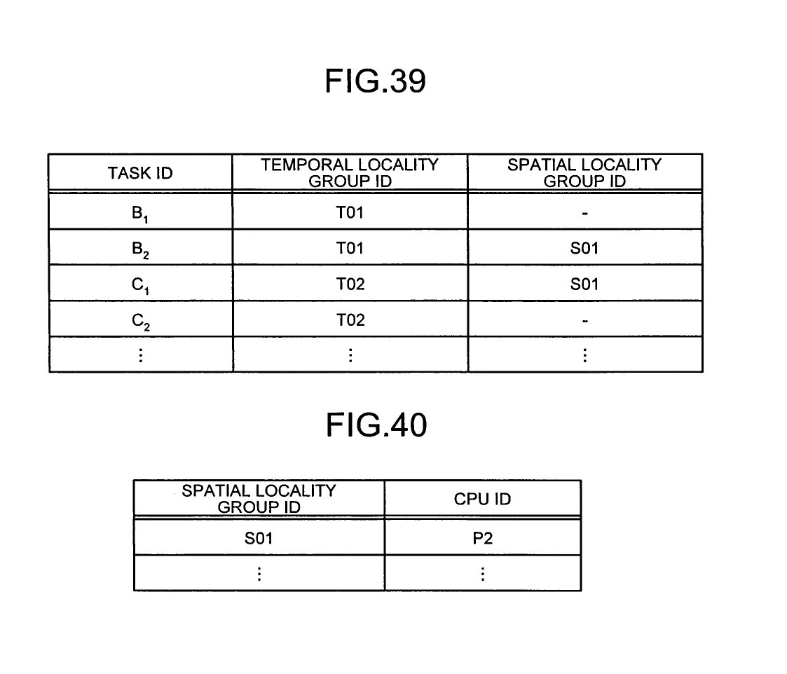

Returning to the description of FIG. 31, the task table 3102 manages the tasks that have been generated by the task generating unit 3105 and are waiting to be processed by the CPUs. As shown in FIG. 39, the task table 3102 stores therein the task IDs, temporal locality group IDs, and spatial locality group IDs, while keeping them in correspondence with one another.

Returning to the description of FIG. 31, the scheduling history storage unit 3103 stores therein an active group correspondence management table and the active group management table. As shown in FIG. 40, the active group correspondence management table stores therein spatial locality group IDs and CPU IDs, while keeping them in correspondence with one another. In other words, in the active group correspondence management table, each of the spatial locality groups that are respectively identified with the spatial locality group IDs is assigned to one of the CPUs that are respectively identified with the CPU IDs.

The active group management table is the same as the one shown in FIG. 7 that has been explained in the first embodiment. Thus, the explanation thereof will be omitted.

Returning to the description of FIG. 31, the scheduling unit 3104 includes a group judging unit 3113, a first assigning unit 3111, a second assigning unit 3112, and an active setting unit 3114.

When tasks are assigned to an arbitrary one of the CPUs, the group judging unit 3113 judges whether there is any active temporal locality group, besides the spatial locality groups that have been assigned to the other CPUs.

In a case where the group judging unit 3113 has judged that there is no active temporal locality group, the first assigning unit 3111 assigns, to the arbitrary one of the CPUs, tasks that are waiting to be processed and do not belong to any of the task groups that have been assigned to the other CPUs, out of the tasks that are managed in the task table 3102.

In a case where the group judging unit 3113 has judged that there are one or more active temporal locality groups, the second assigning unit 3112 assigns the tasks that belong to the one or more active temporal locality groups to the arbitrary one of the CPUs (i.e., the first CPU 22, the second CPU 24, or the third CPU 26). In other words, the second assigning unit 3112 assigns the other tasks that belong to the same temporal locality group as the temporal locality group to which the task that has been assigned to the CPU belongs, before assigning the tasks that do not belong to the temporal locality group.

The active setting unit 3114 makes a setting for the task groups to which the tasks that have been assigned to the arbitrary one of the CPUs (i.e., the first CPU 22, the second CPU 24, or the third CPU 26) by the first assigning unit 3111 belongs. The setting will be explained in detail later.

As explained above, the task management apparatus 3100 according to the fourth embodiment is able to assign the tasks to the CPUs in an appropriate manner, based on the temporal localities and the spatial localities thereof.

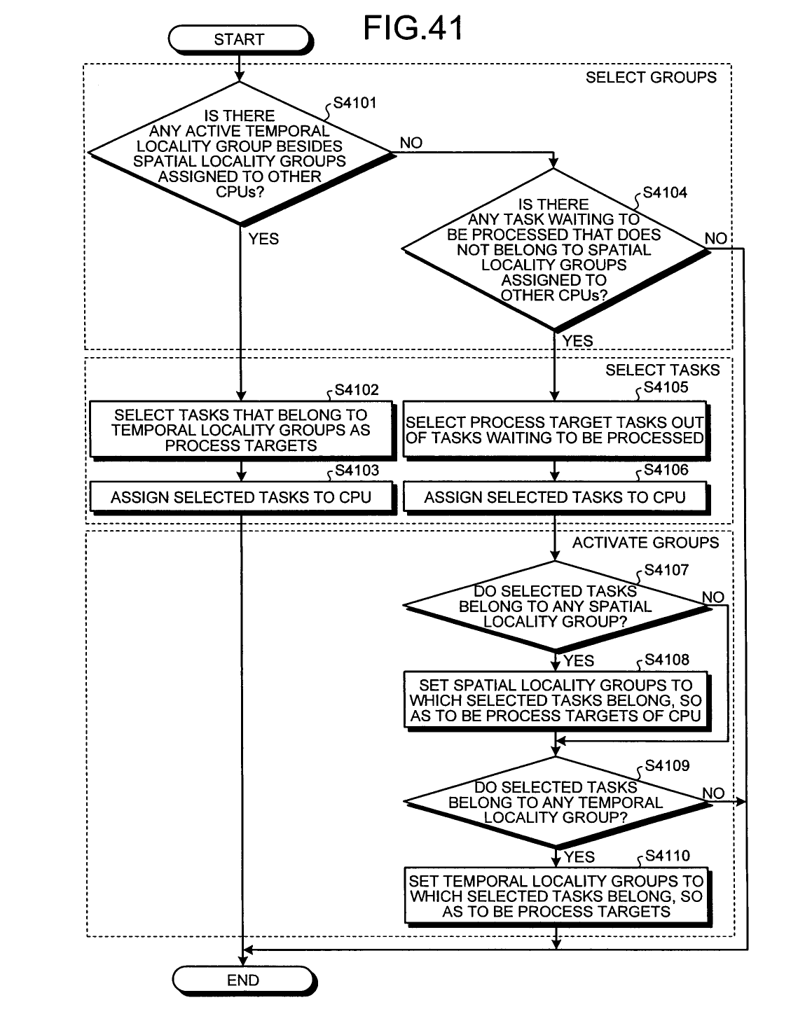

The task management apparatus according to the fourth embodiment is different from the task management apparatus 100 only in the procedure for assigning the tasks to the CPUs. Next, the procedure performed by the task management apparatus 3100 to assign the tasks to the CPUs will be explained with reference to FIG. 41. In the explanation of the processes below, a CPU to which one or more tasks are assigned will be referred to as an “assignment destination CPU”.

First, the group judging unit 3113 judges whether there is any active temporal locality group, besides the spatial locality groups that have been assigned to the other CPUs (i.e., the CPUs other than the assignment destination CPU) (step S4101). The group judging unit 3113 is able to check the task groups that have been assigned to the other CPUs, by referring to the active group correspondence management table shown in FIG. 40.

In a case where the group judging unit 3113 has judged that there are one or more active temporal locality groups (step S4101: Yes), the second assigning unit 3112 selects the tasks that belong to the one or more temporal locality groups as process targets, out of the task table 3102 (step S4102).

After that, the second assigning unit 3112 assigns the selected tasks to the assignment destination CPU (step S4103).

On the contrary, in a case where the group judging unit 3113 has judged that there is no active temporal locality group (step S4101: No), the group judging unit 3113 judges whether there is any task that is waiting to be processed and does not belong to any of the spatial locality groups that have been assigned to the other CPUs (step S4104). In a case where the group judging unit 3113 has judged that there is no task that is waiting to be processed (step S4104: No), the process is ended.

On the contrary, in a case where the group judging unit 3113 has judged that there are one or more tasks that are waiting to be processed (step S4104: Yes), the first assigning unit 3113 selects tasks that serve as process targets, out of the tasks that are stored in the task table 3102 and are waiting to be processed (step S4105).

After that, the first assigning unit 3111 assigns the selected tasks to the assignment destination CPU (Step S4106).

Subsequently, the active setting unit 3114 judges whether the tasks that have been selected by the first assigning unit 3111 belong to any spatial locality group (step S4107).

In a case where the active setting unit 3114 has judged that the selected tasks do not belong to any spatial locality group (step S4107: No), no particular process is performed.

On the contrary, in the case where the active setting unit 3114 has judged that the selected tasks belong to one or more spatial locality groups (step S4107: Yes), the active setting unit 3114 sets the spatial locality groups to which the selected tasks belong, so as to be process targets of the assignment destination CPU (step S4108). According to the fourth embodiment, the active setting unit 3114 registers the IDs that identify the task groups into the active group correspondence management table.

After that, the active setting unit 3114 judges whether the tasks that have been selected by the first assigning unit 3111 belong to any temporal locality group (step S4109). In a case where the active setting unit 3114 has judged that the selected tasks do not belong to any temporal locality group (step S4109: No), no particular process is performed.

On the contrary, in a case where the active setting unit 3114 has judged that the selected tasks belong to one or more temporal locality groups (step S4109: Yes), the active setting unit 3114 sets the one or more temporal locality groups to which the selected tasks belong, so as to be active (step S4110). According to the fourth embodiment, the active setting unit 3114 registers the IDs that identify the one or more temporal locality groups into the active group management table shown in FIG. 7.

In the task management table 3100 according to the fourth embodiment, because the temporal localities and the spatial localities are taken into consideration, it is possible to efficiently assign the tasks to the CPUs. Also, because the tasks are organized into the mutually different groups, based on the temporal localities and the spatial localities, it is possible to perform a more complicated scheduling process. Further, because the procedure for organizing the tasks into the groups is easy, it is possible for a subject (e.g., a developer) who organizes the tasks into the groups to understand the grouping intuitively.

Next, as a fifth embodiment of the present invention, an example will be explained in which, after tasks that have been organized into groups are assigned to CPUs, the assigned tasks are re-assigned to other CPUs.

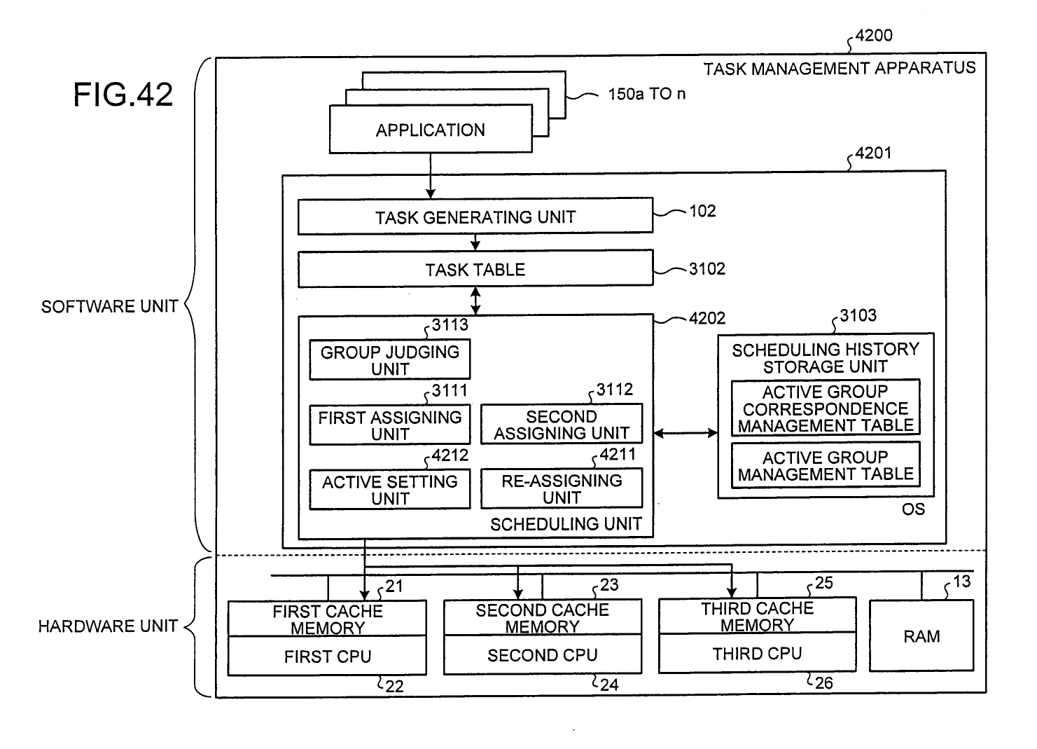

As shown in FIG. 42, a task management apparatus 4200 according to the fifth embodiment is different from the task management apparatus 3100 according to the fourth embodiment described above only in that the task management apparatus 4200 includes an OS 4201 that performs different processes from the ones performed by the OS 3101.

Also, the OS 4201 is different from the OS 3101 according to the fifth embodiment in that the OS 4201 includes a scheduling unit 4202 instead of the scheduling unit 3104. Explanation of the configurations of the task management apparatus 4200 according to the fifth embodiment that are the same as the configurations of the task management apparatus 3100 according to the fourth embodiment will be omitted.

The scheduling unit 4202 includes the group judging unit 3113, the first assigning unit 3111, the second assigning unit 3112, a re-assigning unit 4211, and an active setting unit 4212.

The re-assigning unit 4211 re-assigns spatial locality groups that have been assigned to the CPUs to other task groups (i.e., performs a re-balancing process). More specifically, in a case where an arbitrary one of the CPUs has a larger number of tasks assigned thereto than any other CPUs, the re-assigning 4211 assigns, to the other CPUs, the other tasks that belong to the same spatial locality group as the spatial locality group to which the task that has been assigned to the arbitrary one of the CPUs belongs. The details of the process will be explained later.

In addition to the functions that are the same as those of the active setting unit 3114, the active setting unit 4212 has a function of re-setting temporal locality groups according to the re-assignment performed by the re-assigning unit 4211. More specifically, the active setting unit 4212 updates the active group correspondence management table.

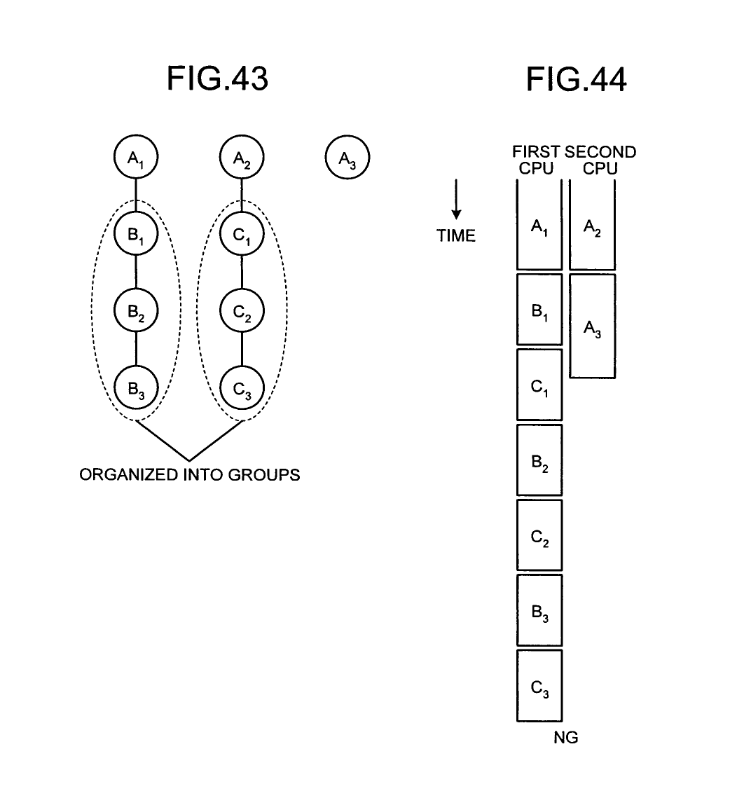

Next, an example in which the tasks are organized into groups as shown in FIG. 43 will be explained. In this example, the tasks B₁, B₂, and B₃ belong to mutually the same spatial locality group. Similarly, the tasks C₁, C₂, and C₃ belong to mutually the same spatial locality group. The lines that connect the tasks denote the dependency relationships among the tasks. In other words, the tasks B₁, B₂, and B₃ that have a dependency relationship need to be processed by mutually the same processor, and also the tasks C₁, C₂, and C₃ that have a dependency relationship need to be processed by mutually the same processor.

In this situation, as shown in FIG. 44, depending on the order in which the tasks are processed, there is a possibility that the spatial locality group containing the tasks B₁, B₂, and B₃ may be assigned to the same CPU (e.g., the first CPU 22) as the CPU to which the spatial locality group containing the tasks C₁, C₂, and C₃ is assigned.

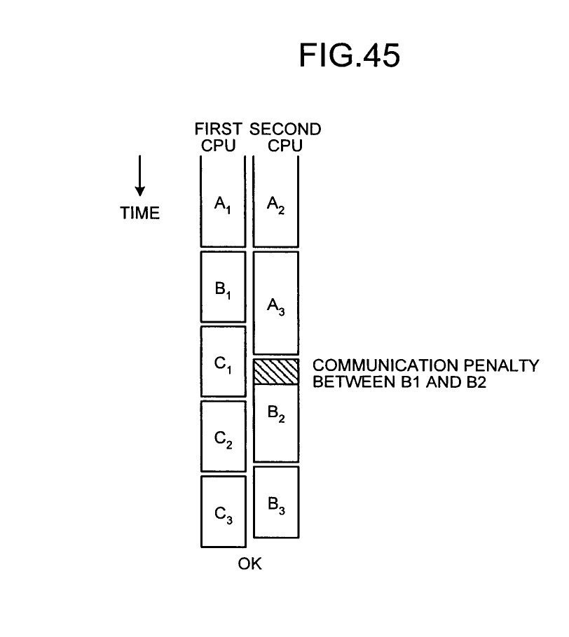

To cope with this situation, the task management apparatus 4200 according to the fifth embodiment performs a re-assigning process (i.e., a re-balancing process) as shown in FIG. 45. More specifically, the task management apparatus 4200 is able to prevent such a situation from occurring where one of the CPUs has a much larger number of process target tasks than other CPUs in an imbalanced manner. Consequently, it is possible to prevent the level of performance from being lowered.

With this arrangement, the first cache memory 21 used by the first CPU 22 and the second cache memory 23 used by the second CPU 24 forward and receive data to and from each other. However, because the second CPU 24 is efficiently utilized, the process efficiency is improved as a result.

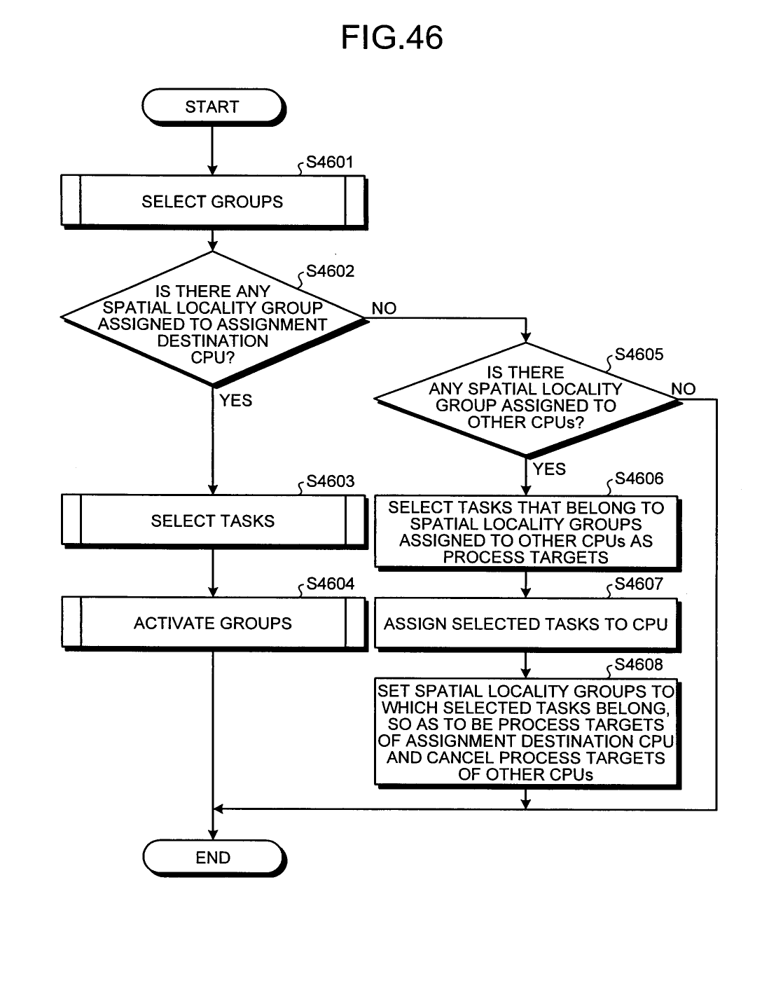

Next, the procedure performed by the task management apparatus 4200 to assign the tasks to the CPUs will be explained, with reference to FIG. 46. In the explanation of the processes below, a CPU to which one or more tasks are assigned will be referred to as an “assignment destination CPU”.

First, by using the process procedure performed at steps S4101 and S4104 shown in FIG. 41, the group judging unit 3113 judges whether there is any temporal locality group being a process target for the assignment destination CPU or any task that is waiting to be processed (step S4601).

Next, the re-assigning unit 4211 judges whether there is any spatial locality group that has been assigned to the assignment destination CPU or any task that is waiting to be processed (step S4602).

In a case where the re-assigning unit 4211 has judged in the affirmative (step S4602: Yes), the tasks that serves as process targets are selected (step S4603), and also task groups are set so as to be active (i.e., groups are activated) (step S4604), by using the process procedure at steps S4102, S4103, and S4105 to S4110 that are shown in FIG. 41.

In a case where the re-assigning unit 4211 has judged that there is no spatial locality group that has been assigned to the assignment destination CPU and there is no task that is waiting to be processed (step S4602: No), the re-assigning unit 4211 judges whether there is any spatial locality group that has been assigned to the other CPUs (Step S4605). In a case where the re-assigning unit 4211 has judged in the negative (step S4605: No), the process is ended.

On the contrary, in a case where the re-assigning unit 4211 has judged that there are one or more spatial locality groups that have been assigned to the other CPUs (step S4605: Yes), the re-assigning unit 4211 selects the tasks that belong to the one or more spatial locality groups that have been assigned to the other CPUs, as process targets (step S4606).

After that, the re-assigning unit 4211 assigns the selected tasks to the assignment destination CPU (step S4607).

Subsequently, the active setting unit 4212 sets the spatial locality groups to which the tasks that have been re-assigned by the re-assigning unit 4211 belong, so as to be process targets of the assignment destination CPU. Also, the active setting unit 4212 cancels the process targets of the other CPUs (step S4608).

In a case where the tasks that need to be processed are assigned to one of the CPUs in an imbalanced manner, the task management apparatus 4200 according to the fifth embodiment adjusts the balance of the loads by dynamically re-scheduling the spatial locality groups. In other words, although a communication penalty is caused by the re-scheduling process, it is possible to inhibit other communication penalties that may follow, because the tasks in each spatial locality group are assigned to mutually the same processor.

Next, as a sixth embodiment of the present invention, an example will be explained in which detailed conditions for assigning the tasks are further defined in a case where there are one or more spatial locality groups and one or more temporal locality groups.

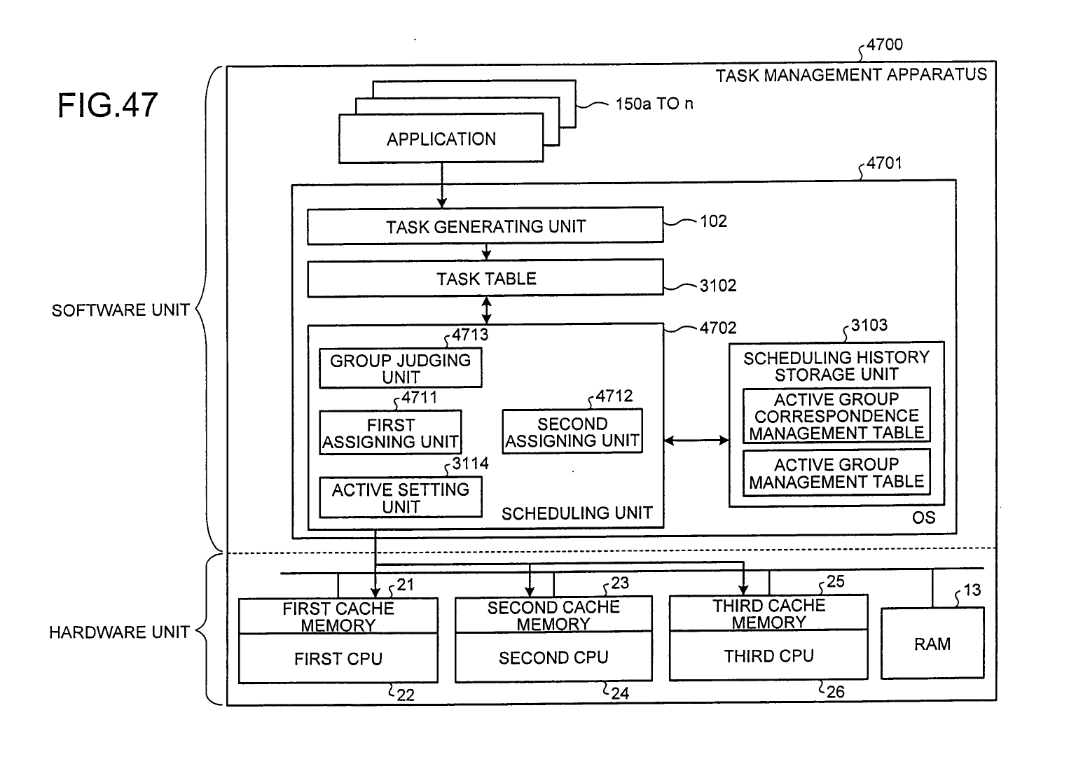

As shown in FIG. 47, a task management apparatus 4700 according to the sixth embodiment is different from the task management apparatus 3100 according to the fourth embodiment only in that the task management apparatus includes an OS 4701 that performs different processes from the processes performed by the OS 3101.

Also, the OS 4701 is different from the OS 3101 according to the fourth embodiment in that the OS 4701 includes a scheduling unit 4702, instead of the scheduling unit 3104. Explanation of the configurations of the task management apparatus 4700 according to the sixth embodiment that are the same as the configurations of the task management apparatus 3100 according to the fourth embodiment will be omitted.

The scheduling unit 4702 includes a group judging unit 4713, a first assigning unit 4711, a second assigning unit 4712, and the active setting unit 3114.

When tasks are assigned to an arbitrary one of the CPUs, the group judging unit 4713 determines a task group that serves as a process target, based on the spatial localities and the temporal localities. The details of the process procedure will be explained later.

The first assigning unit 4711 and the second assigning unit 4712 assign, to the CPUs, the tasks that belong to the task group that has been determined as the process target by the group judging unit 3113.

In a case where any of the tasks that belong to a temporal locality group also belongs to a spatial locality group, the second assigning unit 4712 according to the sixth embodiment assigns such tasks to the CPUs, before assigning the other tasks that do not belong to any spatial locality group. The details of the process procedure will be explained later.

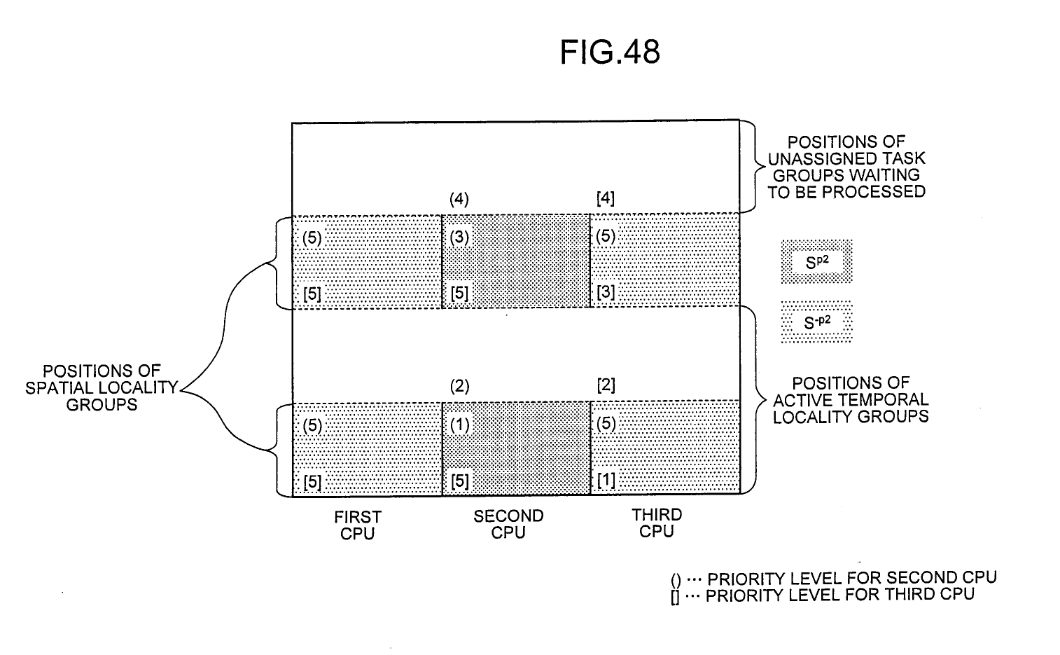

Next, assigning the tasks that belong to the temporal locality group and the spatial locality group will be explained. As shown in the drawing of a concept of a task management performed by the task management apparatus 4700 in FIG. 48, the tasks that belong to a spatial locality group assigned to an arbitrary one of the CPUs cannot be referred to by the other CPUs. Also, as shown in FIG. 48, among the active temporal locality groups, some groups can be executed by only the CPU to which the group is assigned and some groups can be executed by any CPU, depending on the spatial localities thereof.

In FIG. 48, the numbers shown in the parentheses “( )” indicate the priority ranking for the task groups assigned to the second CPU 24. The numbers shown in the brackets “[ ]” indicate the priority ranking for the task groups assigned to the third CPU 26. In the explanation below, S^{p2} denotes a spatial locality group that has been assigned to the second CPU 24, whereas S^{-p2} denotes a spatial locality group that has been assigned to a CPU other than the second CPU 24.

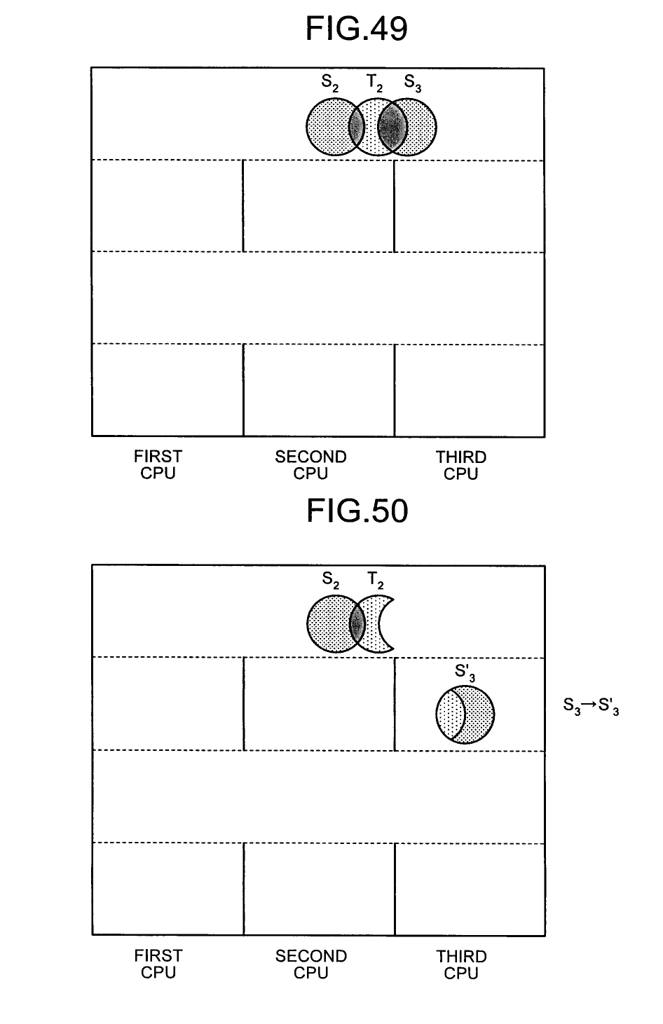

Let us explain an example in which, as shown in FIG. 49, the task management apparatus 4700 has received a spatial locality group S₂, a spatial locality group S₃, and a temporal locality group T₂, as task groups that have not been assigned to any CPUs and are waiting to be processed. The overlapping areas in the drawing indicate that there are some tasks that belong to more than one task group.

After that, as shown in FIG. 50, when the first assigning unit 4711 assigns the spatial locality group S₃ to the third CPU 26, the active setting unit 3114 sets a spatial locality group S′₃ so as to be active. It should be noted that the spatial locality group S′₃ contains some of the tasks that belong to the temporal locality group T₂.

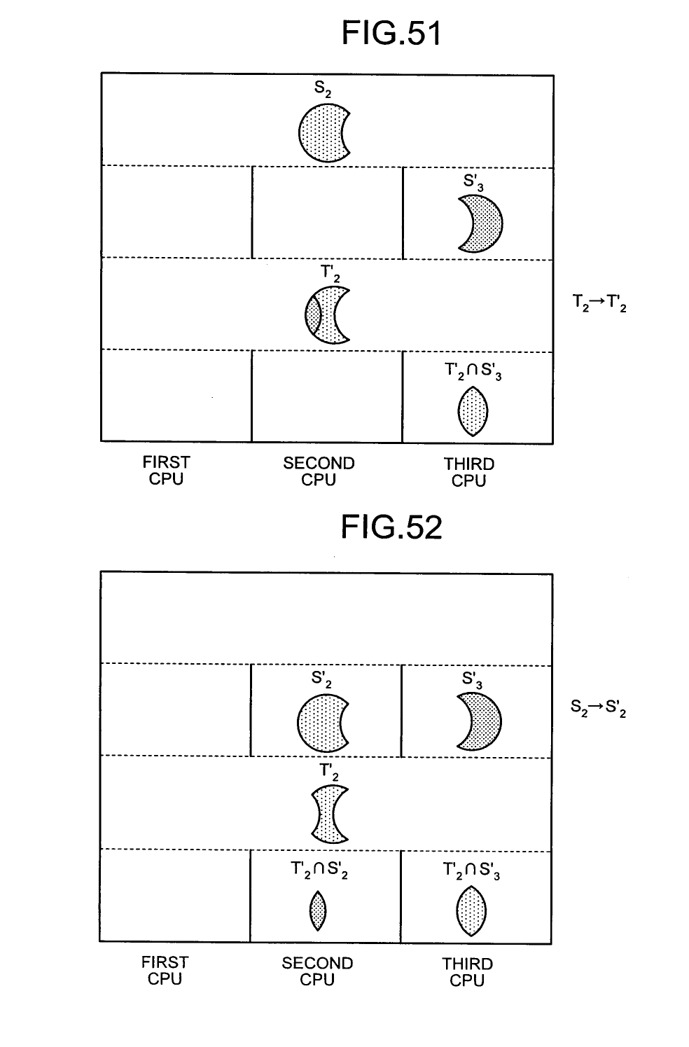

Subsequently, as shown in FIG. 51, the active setting unit 3114 sets the temporal locality group T₂ so as to be active. The temporal locality group T₂ that has been set so as to be active will be referred to as T′₂. As a result, the tasks that belong to both the spatial locality group S′₃ and the temporal locality group T′₂ are arranged to have the highest priority level among the process targets of the third CPU 26.

The tasks that belong to the temporal locality group T′₂ but do not belong to the spatial locality group S′₃ are arranged to have the second highest priority level for each of all the CPUs. Further, the tasks that belong to the spatial locality group S′₃ but do not belong to the temporal locality group T′₂ are arranged to have the third highest priority level among the process targets of the third CPU 26.

After that, as shown in FIG. 52, in a case where the first assigning unit 4711 assigns the spatial locality group S₂ to the second CPU 24, the active setting unit 3114 sets a spatial locality group S′₂ so as to be active. As a result, the tasks that belong to both the spatial locality group S2 and the temporal locality group T′₂ are arranged to have the highest priority level for the second CPU 24.

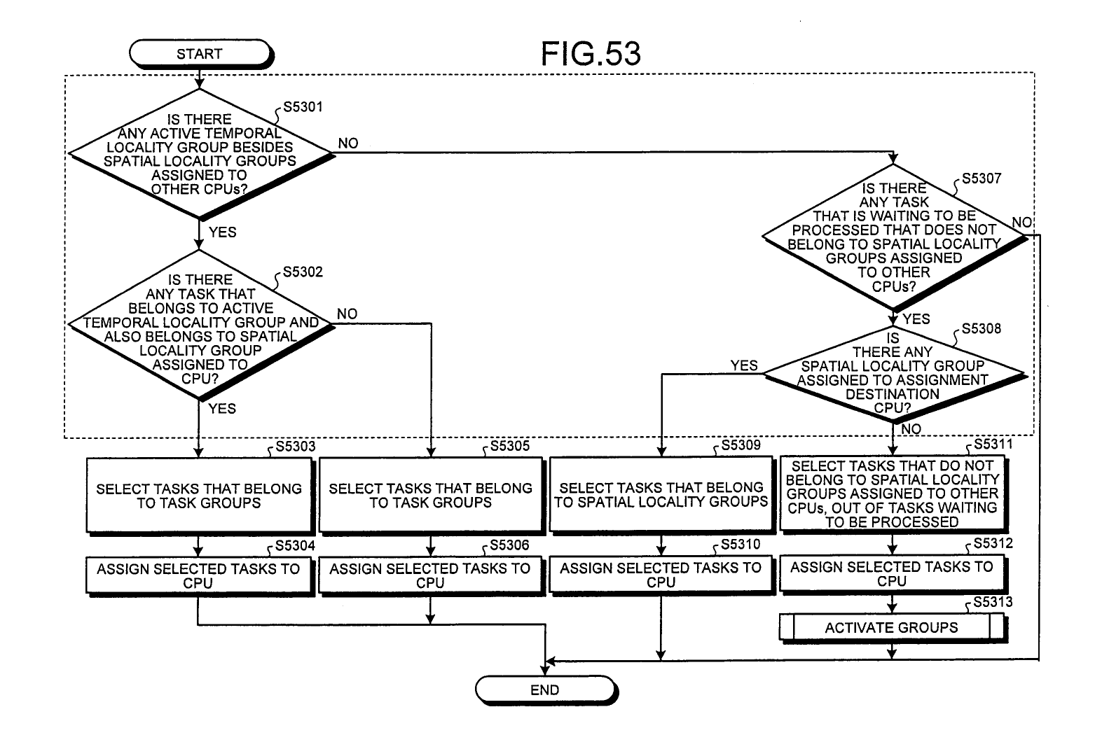

Next, the procedure performed by the task management apparatus 4700 to assign the tasks to the CPUs will be explained with reference to FIG. 53. In the explanation of the processes below, a CPU to which one or more tasks are assigned will be referred to as an “assignment destination CPU”.

The group judging unit 4713 judges whether there is any active temporal locality group besides the spatial locality groups that have been assigned to the other CPUs (i.e., the CPUs other than the assignment destination CPU) (step S5301).

In a case where the group judging unit 4713 has judged that there are one or more active temporal locality groups (step S5301: Yes), the group judging unit 4713 judges whether there is any task that belongs to any of the active temporal locality groups and also belongs to any of the spatial locality groups that have been assigned to the CPU being the assignment destination in the present process procedure (step S5302).

In a case where the group judging unit 4713 has judged that there are one or more tasks each of which belongs to at least one of the active temporal locality groups and also belongs to at least one of the spatial locality groups that have been assigned to the assignment destination CPU (step S5302: Yes), the second assigning unit 4712 selects the one or more tasks as the targets to be processed next (step S5303) and assigns the selected tasks to the assignment destination CPU (step S5304).

On the contrary, in a case where the group judging unit 4713 has judged that there is no such task that belongs to at least one of the active temporal locality groups and also belongs to at least one of the spatial locality groups that have been assigned to the assignment destination CPU (step S5302: No), the second assigning unit 4712 selects the tasks each of which belongs to the one or more active temporal locality groups but does not belong to any of the spatial locality groups that have been assigned to the other CPUs (step S5305) and assigns the selected tasks to the assignment destination CPU (step S5306).

On the other hand, in a case where the group judging unit 4713 has judged that there is no active temporal locality group (step S5301: No), the group judging unit 4713 judges whether there is any task that is waiting to be processed and does not belong to any of the spatial locality groups that have been assigned to the other CPUs (step S5307). In a case where the group judging unit 4713 has judged that there is no task that is waiting to be processed (step S5307: No), the process is ended.

In a case where the group judging unit 4713 has judged that there are one or more tasks each of which is waiting to be processed and does not belong to any of the spatial locality groups that have been assigned to the other CPUs (step S5307: Yes), the group judging unit 4713 judges whether there is any spatial locality group that has been assigned to the assignment destination CPU (Step S5308).

In a case where the group judging unit 4713 has judged that there are one or more spatial locality groups that have been assigned to the assignment destination CPU (step S5308: Yes), the second assigning unit 4712 selects the tasks that belong to the one or more spatial locality groups (step S5309) and assigns the selected tasks to the assignment destination CPU (step S5310).

In a case where the group judging unit 4713 has judged that there is no spatial locality group that has been assigned to the assignment destination CPU (step S5308: No), the first assigning unit 4711 selects tasks that do not belong to any of the spatial locality groups that have been assigned to the other CPUs, out of the tasks that are waiting to be processed (step S5311), and assigns the selected tasks to the assignment destination CPU (step S5312). After that, the active setting unit 3114 sets process targets (i.e., activates groups) by performing the same processes as at steps S4107 to S4110 that are shown in FIG. 41 (step S5313).

It is also acceptable to combine the processes explained for the task management apparatus 4700 according to the sixth embodiment with the re-assigning process explained in the fifth embodiment.

In the example above, the conditions for the tasks to be assigned to the CPUs are specified in detail. With this arrangement, for example, when an active temporal locality group is processed with a priority, the tasks that belong to the spatial locality groups that have been assigned to the processing CPU are processed with a priority. Thus, it is possible to prevent the tasks from being assigned to the CPUs in an imbalanced manner.

As explained above, the task management apparatus 4700 according to the sixth embodiment is able to prevent the tasks from being assigned to the CPUs in an imbalanced manner. Thus, it is possible to make the possibility of maintaining the spatial localities higher.

An arrangement is acceptable in which a task management program executed by any of the task management apparatuses that are explained above in the exemplary embodiments is provided as being recorded on a computer-readable recording medium such as a Compact Disk Read-Only Memory (CD-ROM), a Flexible Disk (FD), a Compact Disk Recordable (CD-R), a Digital Versatile Disk (DVD), in an installable format or in an executable format.

Further, another arrangement is acceptable in which the task management program executed by any of the task management apparatuses that are explained in the exemplary embodiments is stored in a computer connected to a network such as the Internet, so as to be provided as being downloaded via the network. Further, yet another arrangement is acceptable in which the task management program executed by any of the task management apparatuses that are explained in the exemplary embodiments is provided or distributed via a network such as the Internet.

The task management program executed by any of the task management apparatuses that are explained in the exemplary embodiments has a module configuration that includes the functional elements described above. In the actual hardware configuration, when the CPU (i.e., the processor) reads an authentication program from a ROM and executes the read program, the functional elements described above are loaded into a main storage device included in the task management apparatus, so that the functional elements are generated in the main storage device.

The constituent elements that are shown in the software unit included in any of the task management apparatuses that are explained in the exemplary embodiments do not have to be installed as software. Another arrangement is acceptable in which a part or all of the constituent elements are installed as hardware.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A task management apparatus comprising:
a plurality of processors;
a task storage unit that correspondingly stores a plurality of tasks to be assigned to the processors within a predetermined period of time, and temporal groups each of which is assigned to the plurality of the tasks;
a first assigning unit that assigns one of the tasks to one of the processors; and
a second assigning unit that, after the first assigning unit has assigned the one of the tasks to the one of the processors, assigns other tasks that are in correspondence with a same temporal group as a temporal group with which the assigned task is in correspondence, to the one of the processors that has finished processing the assigned task, before assigning tasks that are not in correspondence with the temporal group.

2. The apparatus according to claim 1, wherein
the task storage unit further correspondingly stores the plurality of tasks, and spatial groups obtained by grouping tasks that are assigned to one of processors, and
the second assigning unit further assigns other tasks that are in correspondence with a same spatial group as a spatial group with which the assigned task is in correspondence, to the one of the processors to which the one of the tasks has been assigned by the first assigning unit.

3. The apparatus according to claim 2, wherein the second assigning unit assigns to the one of the processors, the other tasks that are in correspondence with the same spatial group as the spatial group with which the assigned task is in correspondence, before assigning tasks that are not in correspondence with the spatial group.

4. The apparatus according to claim 2, further comprising a re-assigning unit that re-assigns other tasks that are in correspondence with a same spatial group as any of spatial groups with which the tasks assigned to the arbitrary one of the processors are in correspondence, to one of the processors other than the arbitrary one, when an arbitrary one of the processors has a larger number of tasks assigned thereto than any other processors.

5. The apparatus according to claim 1, wherein
the task storage unit stores a plurality of tasks that are to be assigned within a predetermined period of time and are also to be assigned to a mutually same one of the processors and the temporal groups each of which is assigned to the plurality of the tasks, in correspondence with one another, and
the second assigning unit assigns the other tasks that are in correspondence with the same temporal group as the temporal group with which the assigned task is in correspondence, to the one of the processors that has finished processing the one of the tasks assigned by the first assigning unit, before assigning the tasks that are not in correspondence with the temporal group.

6. A task management apparatus comprising:
a processor;
a task storage unit that correspondingly stores a plurality of tasks to be assigned to the processor within a predetermined period of time, and temporal groups each of which is assigned to a plurality of the tasks;
a first assigning unit that assigns one of the tasks to the processor; and
a second assigning unit that assigns to the processor, other tasks that are in correspondence with a same temporal group as a temporal group with which the assigned task is in correspondence, before assigning tasks that are not in correspondence with the temporal group.

7. A task management method comprising:
storing a plurality of tasks that are grouped to temporal groups assigned to processors within a predetermined period of time, and the temporal groups each of which is assigned to the plurality of the tasks, in correspondence with one another;
first assigning one of the tasks to one of the processors; and
second assigning, after the first assigning, other tasks that are in correspondence with a same temporal group as a temporal group with which the assigned task is in correspondence, to the one of the processors that has finished processing the assigned task, before assigning tasks that are not in correspondence with the temporal group.

8. The method according to claim 7, wherein
the storing further correspondingly stores the plurality of tasks, and spatial groups obtained by grouping tasks that are assigned to one of processors, and
the second assigning further assigns other tasks that are in correspondence with a same spatial group as a spatial group with which the assigned task is in correspondence, to the one of the processors to which the one of the tasks has been assigned by the first assigning.

9. The method according to claim 8, wherein the second assigning assigns to the one of the processors, the other tasks that are in correspondence with the same spatial group as the spatial group with which the assigned task is in correspondence, before assigning tasks that are not in correspondence with the spatial group.

10. The method according to claim 8, further comprising re-assigning other tasks that are in correspondence with a same spatial group as any of spatial groups with which the tasks assigned to the arbitrary one of the processors are in correspondence, to one of the processors other than the arbitrary one, when an arbitrary one of the processors has a larger number of tasks assigned thereto than any other processors.

11. The method according to claim 7, wherein
the storing stores a plurality of tasks that are to be assigned within a predetermined period of time and are also to be assigned to a mutually same one of the processors and the temporal groups each of which is assigned to the plurality of the tasks, in correspondence with one another, and
the second assigning assigns the other tasks that are in correspondence with the same temporal group as the temporal group with which the assigned task is in correspondence, to the one of the processors that has finished processing the one of the tasks assigned in the first assigning, before assigning the tasks that are not in correspondence with the temporal group.

12. A computer program product having a computer readable medium including programmed instructions for managing tasks, wherein the instructions, when executed by a computer, cause the computer to perform:
storing a plurality of tasks assigned to processors within a predetermined period of time, and temporal groups each of which is assigned to the plurality of the tasks, in correspondence with one another;
first assigning one of the tasks to one of the processors; and
second assigning, after the first assigning, other tasks that are in correspondence with a same temporal group as a temporal group with which the assigned task is in correspondence, to the one of the processors that has finished processing the assigned task, before assigning tasks that are not in correspondence with the temporal group.

13. The computer program product according to claim 12, wherein
the storing further correspondingly stores the plurality of tasks, and spatial groups obtained by grouping tasks that are assigned to one of processors, and
the second assigning further assigns other tasks that are in correspondence with a same spatial group as a spatial group with which the assigned task is in correspondence, to the one of the processors to which the one of the tasks has been assigned by the first assigning.

14. The computer program product according to claim 13, wherein the second assigning assigns to the one of the processors, the other tasks that are in correspondence with the same spatial group as the spatial group with which the assigned task is in correspondence, before assigning tasks that are not in correspondence with the spatial group.

15. The computer program product according to claim 13, wherein the instructions cause the computer to further perform:
re-assigning other tasks that are in correspondence with a same spatial group as any of spatial groups with which the tasks assigned to the arbitrary one of the processors are in correspondence, to one of the processors other than the arbitrary one, when an arbitrary one of the processors has a larger number of tasks assigned thereto than any other processors.

16. The computer program product according to claim 12, wherein
the storing stores a plurality of tasks that are to be assigned within a predetermined period of time and are also to be assigned to a mutually same one of the processors and the temporal groups each of which is assigned to the plurality of the tasks, in correspondence with one another, and
the second assigning assigns the other tasks that are in correspondence with the same temporal group as the temporal group with which the assigned task is in correspondence, to the one of the processors that has finished processing the one of the tasks assigned in the first assigning, before assigning the tasks that are not in correspondence with the temporal group.
